(19) United States
(12) Patent Application Publication
(10) Pub. No.: US 2018/0195565 A1
(43) Pub. Date: Jul. 12, 2018

(54) REVERSE ROTATION PREVENTION MECHANISM AND MOTOR WITH REDUCER

(71) Applicant: MABUCHI MOTOR CO., LTD., Chiba (JP)

(72) Inventors: Hisashi OGINO, Chiba (JP); Ryoichi SUGITA, Chiba (JP); Toru IMAI, Chiba (JP)

(21) Appl. No.: 15/914,424

(22) Filed: Mar. 7, 2018

Related U.S. Application Data
(63) Continuation of application No. PCT/JP2016/071752, filed on Jul. 25, 2016.

(51) Int. Cl. F16D 63/00; F16H 1/16; F16H 1/00; H02K 7/116; H02K 7/112

(52) U.S. Cl. CPC F16D 63/008; F16H 1/16; F16D 65/08; H02K 7/1166; H02K 7/1125; F16H 1/003

(57) ABSTRACT

A reverse rotation prevention mechanism is provided on a torque transmission path between an output shaft and a driving shaft of a motor, and includes: a relative rotation inhibition unit configured to inhibit rotation of a lock plate provided on the torque transmission path from rotating relative to an output pin when an external force in a rotational direction is exerted on the output shaft; and a lock plate side brake member configured to generate a braking force that prevents reverse rotation when an external force in the rotational direction is exerted on the output shaft, by causing a portion of the lock plate to be pressed. The relative rotation inhibition unit is provided in an area different from the lock plate side brake member.

This application is based upon and claims the benefit of priority from the prior International Patent Application No. PCT/JP2016/071752, filed on Jul. 25, 2016, the entire content of each of which is incorporated herein by reference.

### BACKGROUND OF THE INVENTION

### 1. Field of the Invention

The present invention relates to mechanisms for preventing reverse rotation of a motor used to open or close a power window or sun roof of a vehicle.

### 2. Description of the Related Art

Motors provided with a reducer including a worm and a worm wheel are conventionally known. When used in an automobile power window system for moving a window vertically so as to open or close, motors provided with a reducer are required to have resistance to reverse rotation in order to prevent the window from opening under its own weight or vibration or being opened by a force from outside the vehicle.

Motors with a reducer furnished with a clutch mechanism to implement resistance to reverse rotation have been devised (see patent JP2010-48353). When a drive plate is rotated by an external force exerted from the output side, the clutch mechanism presses the lock plate downward by causing the sloped surface of the drive plate and the sloped surface of the lock plate to come into sliding contact. A frictional force is generated between the lock plate and a facing member as the lock plate is thrust against the facing member, preventing the rotation of the lock plate and preventing reverse rotation due to an external force.

In the above-described clutch mechanism, the lock plate is pressed toward the facing member by a wave washer. For this reason, the lock plate slides over the facing member when the motor is driven, producing loss in the transmission torque. Further, abrasion of the facing member and the lock plate due to the sliding action could give rise to instability in frictional force in the presence of abrasion powder or to reduction in life.

### SUMMARY OF THE INVENTION

The present invention addresses these issues and a purpose thereof is to provide a mechanism that realizes stable anti-reverse-rotation performance.

A reverse rotation prevention mechanism according to an embodiment of the present invention is provided on a torque transmission path between an output shaft and a driving shaft of a motor, and includes: a relative rotation inhibition unit configured to inhibit rotation of a braking rotational member provided on the torque transmission path from rotating relative to another member when an external force in a rotational direction is exerted on the output shaft; and a first braking force generation unit configured to generate a braking force that prevents reverse rotation when an external force in the rotational direction is exerted on the output shaft, by causing a portion of the braking rotational member to be pressed. The relative rotation inhibition unit is provided in an area different from the first braking force generation unit.

### BRIEF DESCRIPTION OF THE DRAWINGS

Embodiments will now be described by way of examples only, with reference to the accompanying drawings which are meant to be exemplary, not limiting and wherein like elements are numbered alike in several Figures in which:

FIG. 1A is a perspective view of a motor with a reducer, and FIG. 1B is a perspective view of the motor with a reducer viewed from a direction different from that of FIG. 1A;

FIG. 2 is a fragmentary sectional view of the motor with a reducer according to reference example 1;

FIG. 3 is an exploded perspective view of the reverse rotation prevention mechanism according to reference example 1;

FIG. 4 is an enlarged sectional view of the neighborhood of the reverse rotation prevention mechanism shown in FIG. 2;

FIG. 5A is a perspective view of the first casing, and FIG. 5B is a perspective view of the first casing viewed from a direction different from that of FIG. 5A;

FIG. 6 is a sectional view of the first casing;

FIG. 7 is a perspective view of the output plate side brake member;

FIG. 8 is a sectional view of the output plate side brake member;

FIG. 9 is a perspective view of the sleeve;

FIG. 10 is a sectional view of the sleeve;

FIG. 11A is a perspective view of the output plate, and FIG. 11B is a perspective view of the output plate viewed from a direction different from that of FIG. 11A;

FIG. 12A is a sectional view along A-A of the output plate shown in FIG. 11A, and FIG. 12B is a sectional view along B-B of the output plate shown in FIG. 11A;

FIG. 13A is a perspective view of the lock plate, and FIG. 13B is a perspective view of the lock plate viewed from a direction different from that of FIG. 13A;

FIG. 14A is a sectional view along C-C of the lock plate shown in FIG. 13A, and FIG. 14B is a sectional view along D-D of the lock plate shown in FIG. 13A;

FIG. 15 is a perspective view of the lock plate side brake member;

FIG. 16 is a sectional view of the lock plate side brake member;

FIG. 17A is a perspective view of the output pin, and FIG. 17B is a perspective view of the output pin viewed from a direction different from that of FIG. 17A;

FIG. 18A is a sectional view along E-E of the output pin shown in FIG. 17A, and FIG. 18B is a sectional view along F-F of the output pin 46 shown in FIG. 17A;

FIG. 19 is an exploded perspective view of an important part of the reverse rotation prevention mechanism according to reference example 1;

FIG. 20 is a schematic diagram illustrating how the components work when an external force in the rotational direction is exerted on the output shaft;

FIG. 21 is a schematic diagram illustrating how the reverse rotation prevention mechanism works when an external force in the rotational direction is exerted on the output shaft;

FIG. 22 is a schematic diagram illustrating the action performed when the motor in the state shown in FIG. 20 where the reverse rotation prevention mechanism is functioning is driven in the counterclockwise direction (CCW);

FIG. 23 is a schematic diagram illustrating the action performed when the motor in the state shown in FIG. 20 where the reverse rotation prevention mechanism is functioning is driven in the clockwise direction (CW);

FIG. 24 is a schematic diagram illustrating a frictional force generation unit according to reference example 1;

FIG. 25 shows a relationship between a cone angle θ and a pressing force Y;

FIG. 26 is an exploded perspective view of a reverse rotation prevention mechanism according to reference example 2;

FIG. 27 is an enlarged sectional view of the neighborhood of the reverse rotation prevention mechanism according to reference example 2;

FIG. 28A is a perspective view of a lock plate according to reference example 2, and FIG. 28B is a perspective view of the lock plate viewed from a direction different from that of FIG. 28A;

FIG. 29A is a perspective view of the output pin according to reference example 2, and FIG. 29B is a perspective view of the output plate viewed from a direction different from that of FIG. 29A;

FIG. 30A is a schematic diagram illustrating the action performed since the motor with a reducer provided with the reverse rotation prevention mechanism shown in reference example 2 is driven in the clockwise direction until the motor is stopped; and FIG. 30B is a schematic diagram illustrating the action performed when an external force in the counterclockwise direction is input to the output plate in the state shown in FIG. 30A;

FIG. 31 is an exploded perspective view of the reverse rotation prevention mechanism according to the first embodiment;

FIG. 32 is an enlarged sectional view of the neighborhood of the reverse rotation prevention mechanism according to the first embodiment;

FIG. 33 is a perspective view of the output plate side brake member according to the first embodiment;

FIG. 34 is a sectional view of the output plate side brake member according to the first embodiment;

FIG. 35A is a perspective view of the output plate according to the first embodiment, and FIG. 35B is a perspective view of the output plate viewed from a direction different from that of FIG. 35A;

FIG. 36A is a sectional view along G-G of the output plate shown in FIG. 35A, and FIG. 36B is a sectional view along H-H of the output plate shown in FIG. 35A;

FIG. 37A is a perspective view of a lock plate according to the first embodiment, and FIG. 37B is a perspective view of the lock plate viewed from a direction different from that of FIG. 37A;

FIG. 38A is a sectional view along J-J of the lock plate shown in FIG. 37A, and FIG. 38B is a sectional view along K-K of the lock plate shown in FIG. 37A;

FIG. 39 is a perspective view of the lock plate side brake member according to the first embodiment;

FIG. 40 is sectional view of the lock plate side brake member according to the first embodiment;

FIG. 41 is a schematic diagram illustrating the action performed since the motor provided with the reverse rotation prevention mechanism according to the first embodiment is driven in the clockwise direction (CW) until the motor is stopped;

FIG. 42 is a schematic diagram illustrating the action of the reverse rotation prevention mechanism performed when an external force in the counterclockwise direction is input to the output plate in the state shown in FIG. 41 in which the motor is at rest;

FIG. 43 is a schematic diagram illustrating the action of the reverse rotation prevention mechanism performed when an external force in the clockwise direction is input to the output plate in the state shown in FIG. 41 in which the motor is at rest;

FIG. 44 is a schematic diagram of a unit including a combination of the output pin, output plate, and lock plate according to the second embodiment;

FIG. 45A is a perspective view of the output pin according to the third embodiment, and FIG. 45B is a top view of the output pin shown in FIG. 45A; and

FIG. 46A is a front view of the output pin shown in FIG. 45B viewed from a direction of arrow X1; FIG. 46B is a side view of the output pin shown in FIG. 45B viewed from a direction of arrow Y1; and FIG. 46C is a sectional view along L-L of the output pin shown in FIG. 45B.

### MODE FOR CARRYING OUT THE INVENTION

### DETAILED DESCRIPTION OF THE INVENTION

A reverse rotation prevention mechanism according to an embodiment of the present invention is provided on a torque transmission path between an output shaft and a driving shaft of a motor, and includes: a relative rotation inhibition unit configured to inhibit rotation of a braking rotational member provided on the torque transmission path from rotating relative to another member when an external force in a rotational direction is exerted on the output shaft; and a first braking force generation unit configured to generate a braking force that prevents reverse rotation when an external force in the rotational direction is exerted on the output shaft, by causing a portion of the braking rotational member to be pressed. The relative rotation inhibition unit is provided in an area different from the first braking force generation unit.

According to this embodiment, the first braking force generation unit can be primarily configured to generate a braking force that prevents reverse rotation. Meanwhile, the relative rotation inhibition unit can be primarily configured to inhibit the rotation of the braking rotational member relative to another member. By providing the first braking force generation unit and the relative rotation inhibition unit, which are required to provide different functions, at separate areas, optimization and flexibility of design are promoted. For this reason, stable anti-reverse-rotation performance can be maintained for a long period of time.

The other member may be a driving shaft side rotational member provided on the torque transmission path more toward the driving shaft of the motor than the braking rotational member. The driving shaft side rotational member may be engaged with and rotated along with the braking rotational member when the motor is driven. The relative rotation inhibition unit may be configured to generate an attractive force between the braking rotational member and the driving shaft side rotational member. This makes it difficult for the braking rotational member to move relative to the driving shaft side rotational member and inhibits the braking rotational member from rotating in tandem with another rotating body when an external force in the rotational direction is exerted on the output shaft.

The relative rotation inhibition unit may be configured to disengage the braking rotational member and the driving shaft side rotational member from each other when the motor is stopped with the braking rotational member and the driving shaft side rotational member being engaged with each other.

The relative rotation inhibition unit may include a magnet or a magnetic material provided in the braking rotational member and includes a magnetic material or a magnet provided in the driving shaft side rotational member. The relative rotation inhibition mechanism may be configured to generate a magnetic attraction force between the braking rotational member and the driving shaft side rotational member. This can disengage the braking rotational member and the driving shaft rotational member from each other without providing a complicated mechanism.

The reverse rotation prevention mechanism may further include a braking and pressing member configured to be spaced apart from the braking rotational member due to a reactive force responsive to a force that presses the braking rotational member against the first braking force generation unit when an external force in the rotational direction is exerted on the output shaft; and a second braking force generation unit configured to generate a braking force that prevents reverse rotation when an external force in the rotational direction is exerted on the output shaft, by causing a portion of the baking and pressing member to be pressed. This can generate a large braking force.

Another embodiment of the present invention relates to a motor with a reducer. The motor with a reducer includes: a motor; a worm to which a rotational force of a driving shaft of the motor is transmitted; a worm wheel in mesh with the worm; an output shaft to which the rotational force exerted on the worm wheel is transmitted; and the above reverse rotation prevention mechanism. By using a motor like this to open or close a power window or sun roof of a vehicle, for example, the window is prevented from opening under its own weight or vibration or being opened by a force from outside the vehicle.

The reverse rotation prevention mechanism may be provided on a torque transmission path between the driving shaft of the motor and the worm. This ensures that the external force exerted on the output shaft is reduced by the worm and the worm wheel before being exerted on the reverse rotation prevention mechanism, making it possible to lower the strength of members constituting the reverse rotation prevention mechanism.

Optional combinations of the aforementioned constituting elements, and implementations of the invention in the form of methods, apparatuses, and systems may also be practiced as additional modes of the present invention.

According to the present invention, stable anti-reverse-rotation performance is realized.

The motor with a reducer according to the present invention is applicable to devices adapted to reduce motor rotation and move an object accordingly. For example, the inventive motor can be suitably used in devices like a power window system, sun roof, power seat, door closure, etc. of a vehicle in which resistance to reverse rotation is required.

A description will be given of an embodiment of the present invention with reference to the drawings. Like numerals represent like elements so that the description will be omitted accordingly. The structure described below is by way of example only and does not limit the scope of the invention.

(Motor with Reducer)

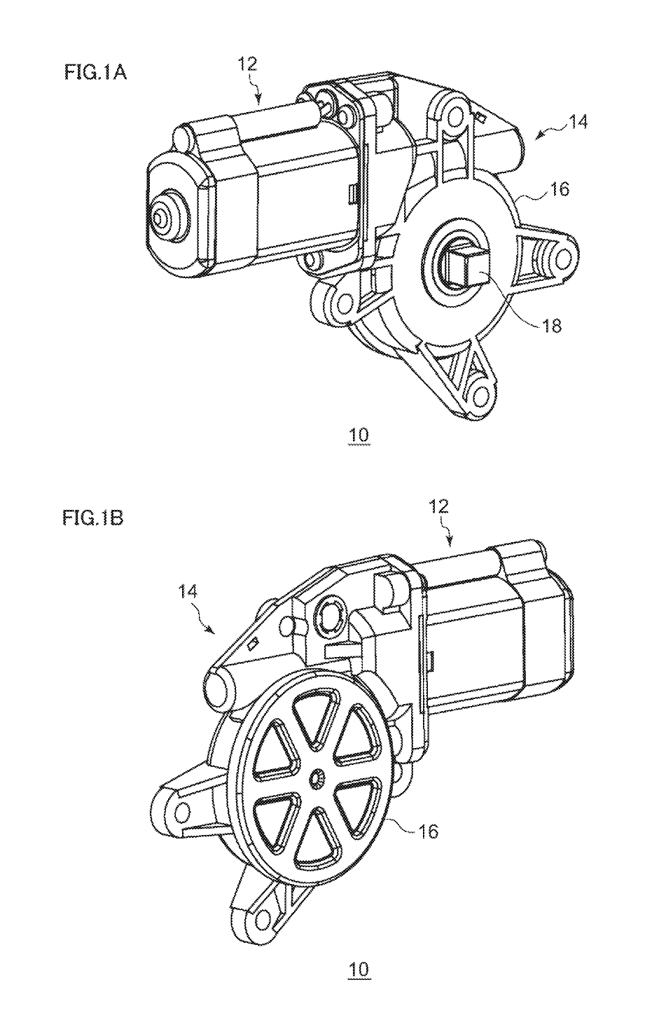

A description will be given of a schematic structure of the motor with a reducer. FIG. 1A is a perspective view of a motor with a reducer, and FIG. 1B is a perspective view of the motor with a reducer viewed from a direction different from that of FIG. 1A.

A DC motor 10 with a reducer includes a motor 12 (DC motor) and a reducer 14 coupled to the shaft of the motor 12. The reducer 14 includes a cylindrical housing 16 that houses a worm wheel described later. An output shaft 18 projects from one of the surfaces of the housing 16 of the reducer 14.

### REFERENCE EXAMPLE 1

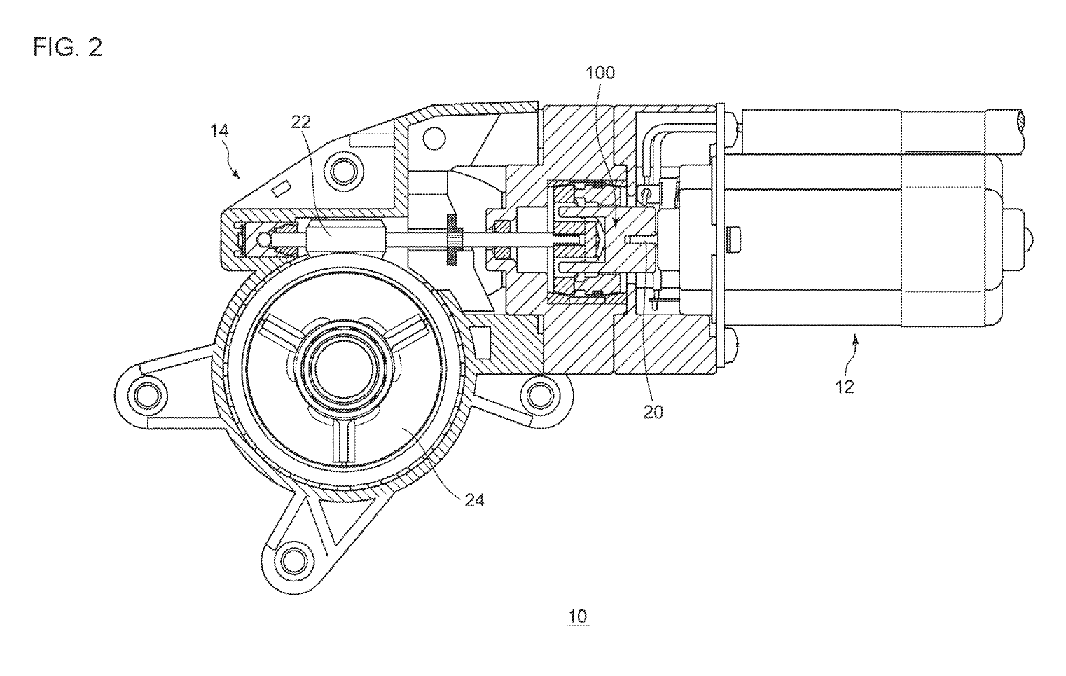

A description will be given of the main configuration and operation of the reverse rotation prevention mechanism according to the embodiment with reference to the reverse rotation prevention mechanism according to reference examples 1, 2. FIG. 2 is a fragmentary sectional view of the motor with a reducer according to reference example 1. The reducer 14 of the motor 10 includes a worm 22, a worm wheel 24 configured to be in mesh with the worm 22, an output shaft 18 (see FIG. 1A), and a reverse rotation prevention mechanism 100. The rotational force of a driving shaft 20 of the motor 12 is transmitted to the worm 22, and the rotational force exerted on the worm wheel 24 is transmitted to the output shaft 18. The reverse rotation prevention mechanism 100 is provided on a torque transmission path between the driving shaft 20 of the motor 12 and the worm 22.

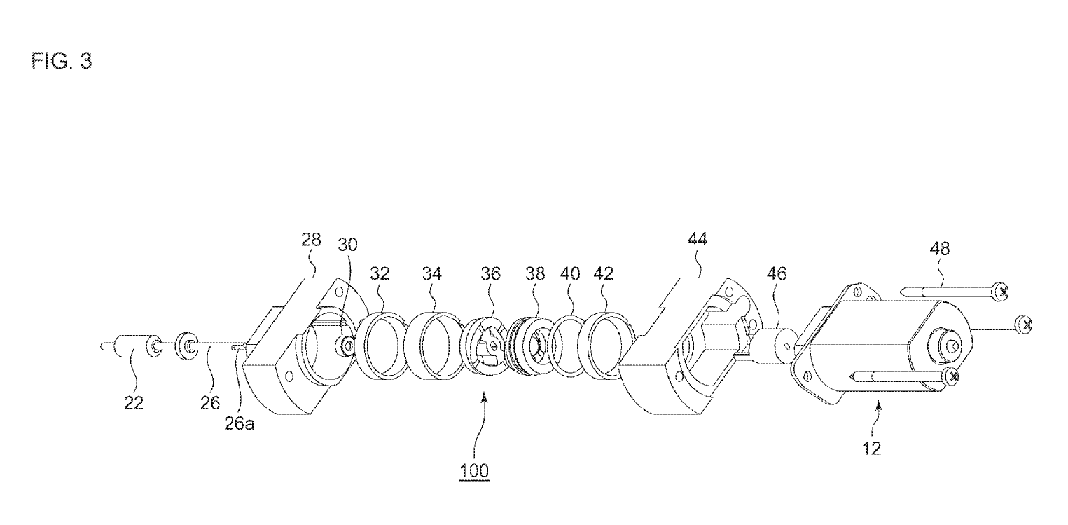

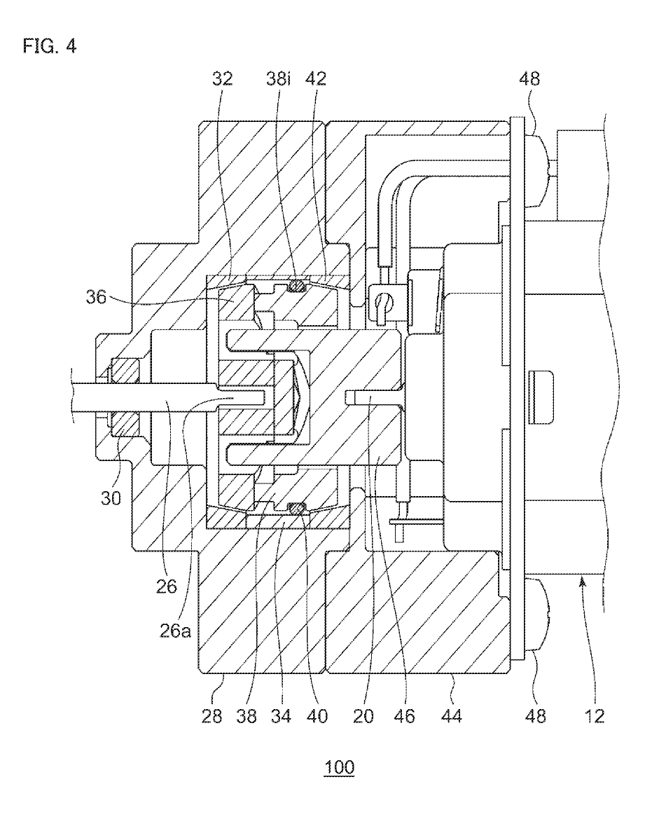

FIG. 3 is an exploded perspective view of the reverse rotation prevention mechanism 100 according to reference example 1. FIG. 4 is an enlarged sectional view of the neighborhood of the reverse rotation prevention mechanism shown in FIG. 2.

The reverse rotation prevention mechanism 100 is provided on a torque transmission path between the driving shaft 20 of the motor 12 and a gear side shaft 26 to which the worm 22 is fixed. The reverse rotation prevention mechanism 100 includes a first casing 28, a sintered bearing 30, an output plate side brake member 32, a sleeve 34, an output plate 36, a lock plate 38, an O-ring 40, a lock plate side brake member 42, a second casing 44, and an output pin 46. The first casing 28 and the second casing 44 are integrated with the motor 12 by tapping screws 48.

[First Casing]

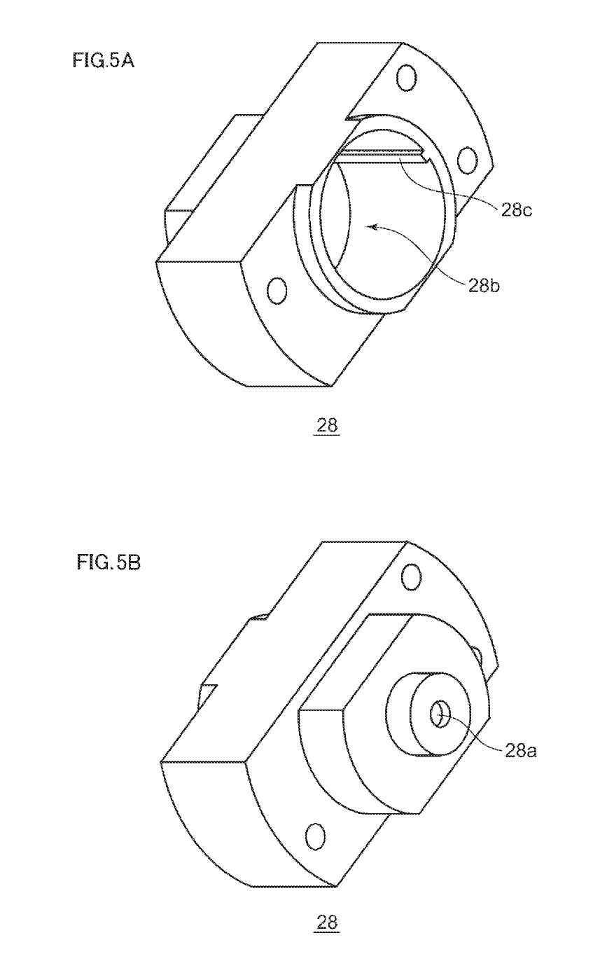

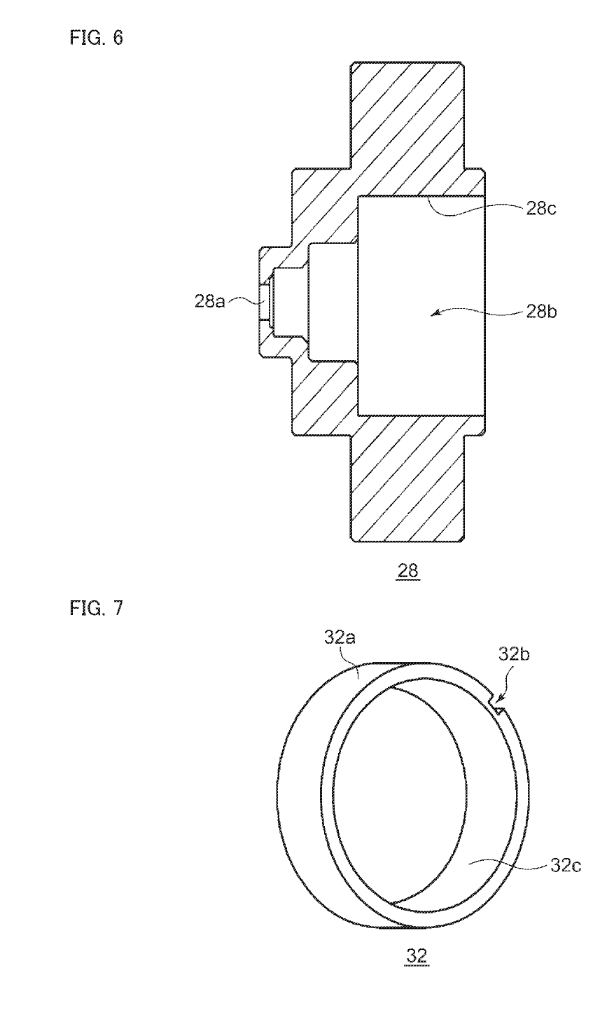

FIG. 5A is a perspective view of the first casing 28, and FIG. 5B is a perspective view of the first casing 28 viewed from a direction different from that of FIG. 5A. FIG. 6 is a sectional view of the first casing 28. The first casing 28 is formed with a through hole 28a through which the gear side shaft 26 is inserted and a cylindrical recess 28b that accommodates the output plate side brake member 32, the sleeve 34, and the lock plate side brake member 42. The inner circumferential portion of the recess 28b is formed with a convex anchoring portion 28c parallel to the axial direction of the gear side shaft 26 that prevents the output plate side brake member 32, the sleeve 34, and the lock plate side brake member 42 from being rotated in the recess 28b.

[Output Plate Side Brake Member]

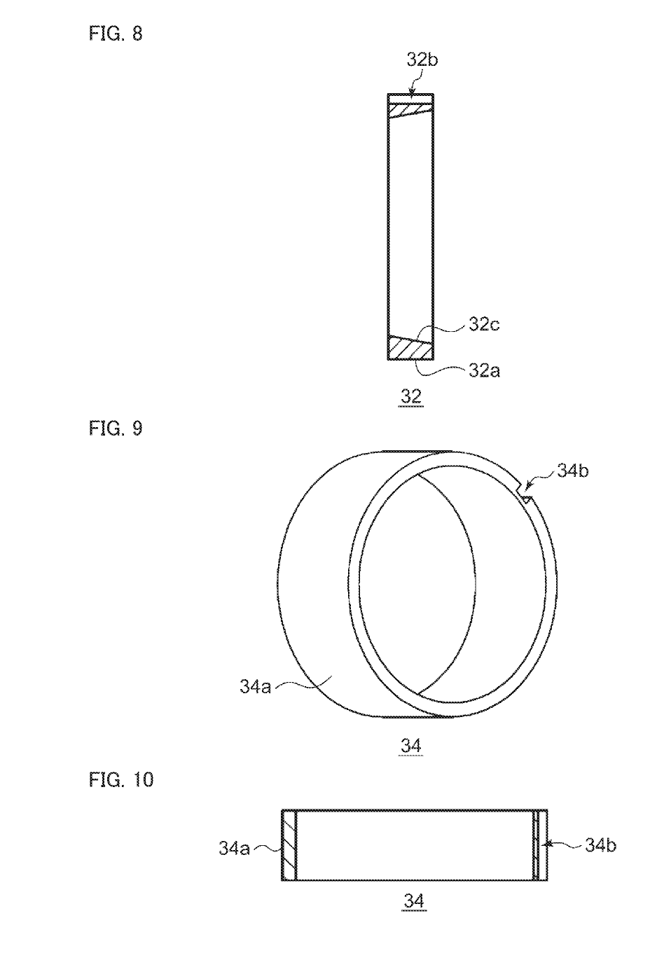

FIG. 7 is a perspective view of the output plate side brake member 32. FIG. 8 is a sectional view of the output plate side brake member 32. The output plate side brake member 32 is an annular member having a uniform diameter. An outer circumferential surface 32a is formed with a groove-like anchoring recess 32b parallel to the axial direction. The output plate side brake member 32 has a sloped brake surface 32c having an inner diameter that varies in the axial direction. The output plate side brake member 32 is inserted into the recess 28b of the first casing 28 such that the anchoring recess 32b is aligned with the convex anchoring portion 28c of the first casing 28.

[Sleeve]

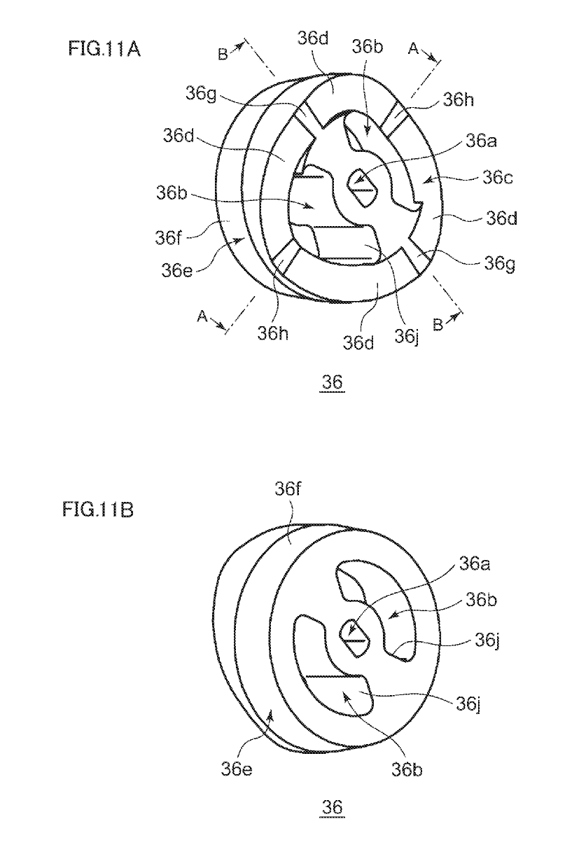

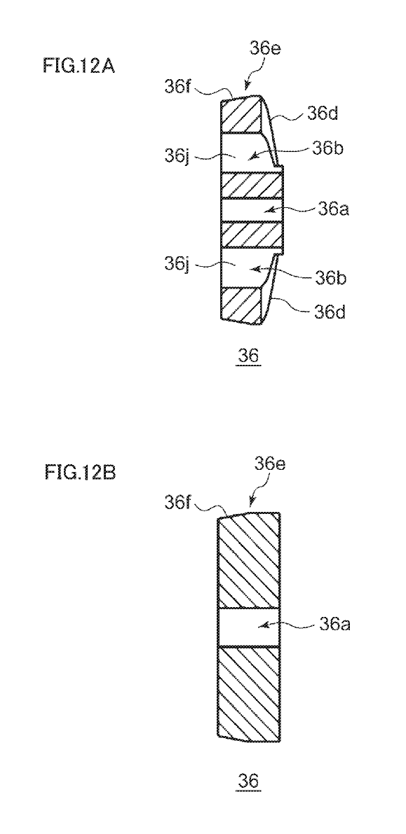

FIG. 9 is a perspective view of the sleeve 34. FIG. 10 is a sectional view of the sleeve 34. The sleeve 34 is an annular member and a groove-like anchoring recess 34b parallel to the axial direction is formed on an outer circumferential surface 34a. The sleeve 34 is inserted into the recess 28b of the first casing 28 such that the anchoring recess 34b is aligned with the convex anchoring portion 28c of the first casing 28.

[Output Plate]

FIG. 11A is a perspective view of the output plate 36, and FIG. 11B is a perspective view of the output plate 36 viewed from a direction different from that of FIG. 11A. FIG. 12A is a sectional view along A-A of the output plate 36 shown in FIG. 11A, and FIG. 12B is a sectional view along B-B of the output plate 36 shown in FIG. 11A.

The output plate 36 is a cylindrical member and is formed at the center with a through hole 36a in which the gear side shaft 26 is inserted. Further, the neighborhood of the center formed with the through hole 36a is formed with two arc-like through holes 36b configured such that the output pin 46 is rotatable in both directions around the 5rotational axis when portions of the output pin 46 advance into the through holes 36b. The through hole 36b has an inner wall 36j that comes into contact with a portion of the output pin 46 when the output pin 46 is rotated. An end face 36c of the output plate 36 that faces the lock plate 38 has four arc-like sloped portions 36d formed on the outer circumference of the output plate 36 in the circumferential direction. The sloped portion 36d is configured such that the height thereof in the axial direction gradually increases or decreases depending on the position in the circumferential direction. A peak 36g or a trough 36h is formed between two adjacent sloped portions 36d so as to alternate.

The through hole 36a is configured to permit the axial movement of the gear side shaft 26 inserted into the through hole 36a. A portion of an outer circumferential surface 36e of the output plate 36 functions as a brake surface 36f. The brake surface 36f according to the embodiment is a tapered surface.

[Lock Plate]

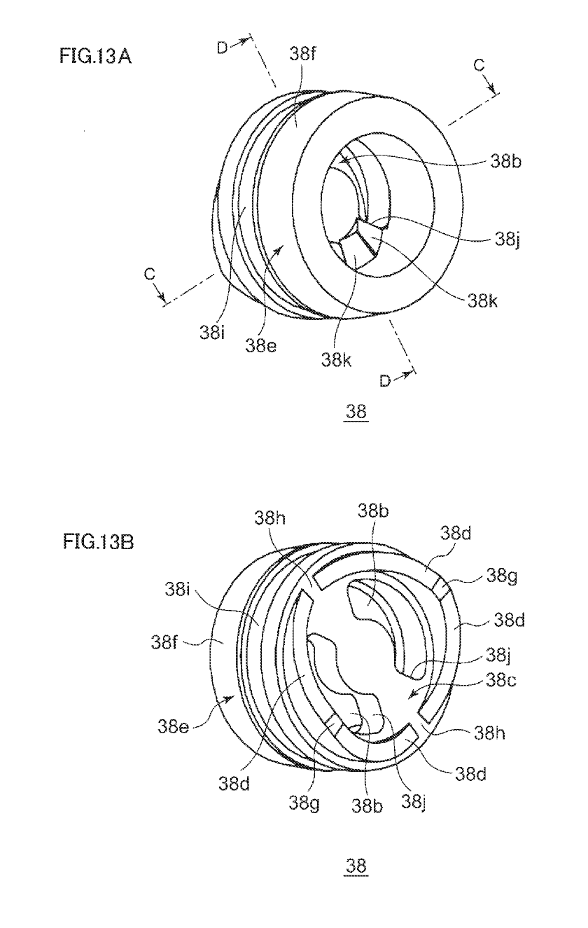

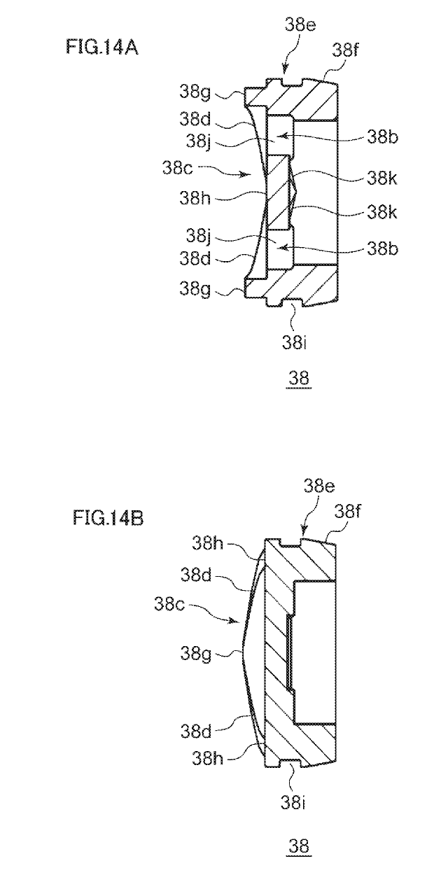

FIG. 13A is a perspective view of the lock plate 38, and FIG. 13B is a perspective view of the lock plate 38 viewed from a direction different from that of FIG. 13A. FIG. 14A is a sectional view along C-C of the lock plate 38 shown in FIG. 13A, and FIG. 14B is a sectional view along D-D of the lock plate 38 shown in FIG. 13A.

The lock plate 38 is a cylindrical member. The neighborhood of the center thereof is formed with two arc-like through holes 38b configured such that the output pin 46 is rotatable in both directions around the rotational axis when portions of the output pin 46 advance into the through holes 38b. The through hole 36b has an inner wall 38j that comes into contact with a portion of the output pin 46 when the output pin 46 is rotated. Four sloped portions 38k that form a spacing mechanism for causing the lock plate 38 to be spaced apart from the lock plate side brake member 42 are formed between two through holes 38b. An end face 38c of the lock plate 38 that faces the output plate 36 has four sloped portions 38d formed on the outer circumference of the lock plate 38 in the circumferential direction. The sloped portion 38d is configured such that the height thereof in the axial direction gradually increases or decreases depending on the position in the circumferential direction. A peak 38g or a trough 38h is formed between two adjacent sloped portions 38d.

A portion of an outer circumferential surface 38e of the lock plate 38 functions as a brake surface 38f. The brake surface 38f according to the embodiment is a tapered surface. The outer circumferential surface 38e of the lock plate 38 is formed with a groove 38i to which the O-ring 40 is fitted.

(Lock Plate Side Brake Member]

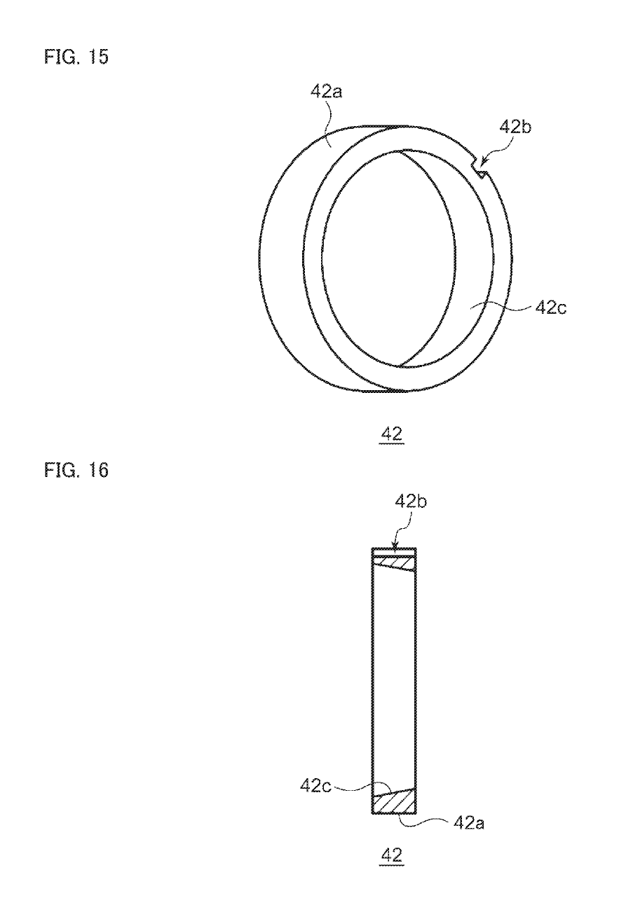

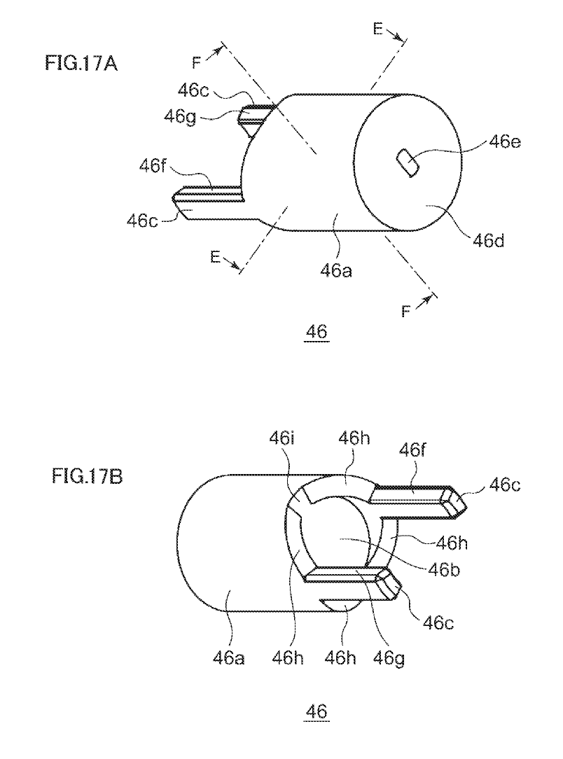

FIG. 15 is a perspective view of the lock plate side brake member 42. FIG. 16 is a sectional view of the lock plate side brake member 42. The lock plate side brake member 42 is an annular member having a uniform outer diameter. A groove-like anchoring recess 42b parallel to the axial direction is formed in an outer circumferential surface 42a of the lock plate side brake member 42. The lock plate side brake member 42 has a sloped brake surface 42c having an inner diameter that varies in the axial direction. The lock plate side brake member 42 is inserted into the recess 28b of the first casing 28 such that the anchoring recess 42b is aligned with the convex anchoring portion 28c of the first casing 28.

[Output Pin]

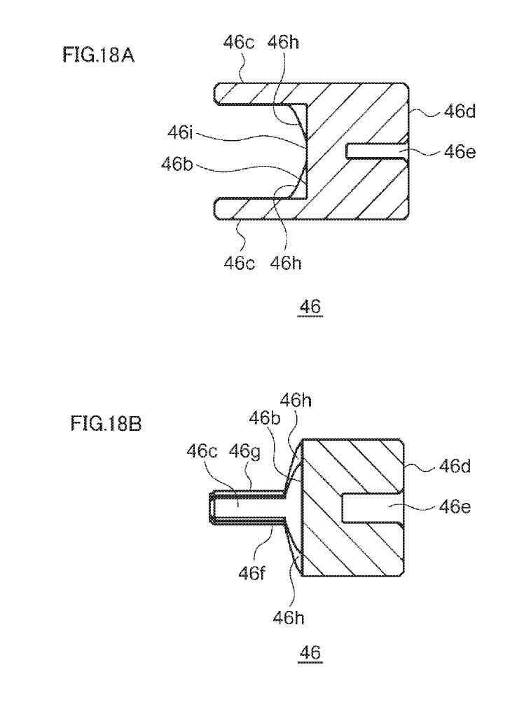

FIG. 17A is a perspective view of the output pin 46, and FIG. 17B is a perspective view of the output pin 46 viewed from a direction different from that of FIG. 17A. FIG. 18A is a sectional view along E-E of the output pin 46 shown in FIG. 17A, and FIG. 18B is a sectional view along F-F of the output pin 46 shown in FIG. 17A.

The output pin 46 has a cylindrical main portion 46a and two convex engaging portions 46c provided to project from one end face 46b of the main portion 46a in the axial direction. Another end face 46d of the main portion 46a is formed with a press fitting hole 46e in which the driving shaft 20 is press fitted. The convex engaging portions 46c are of a form rotatable when the engaging portions 46c advance into the through hole 38b of the lock plate 38 and the through hole 36b of the output plate 36. Further, the convex engaging portions 46c have engaging surfaces 46f and 46g, respectively, that are engaged with the inner wall 38j of the through hole 38b of the lock plate 38 and the inner wall 36j of the through hole 36b of the output plate 36 when the motor is driven.

An end face 46b of the output pin 46 has four arc-like sloped portions 46h formed on the outer circumference of the output pin 46 in the circumferential direction. The sloped portion 46h is configured such that the height thereof in the axial direction gradually increases or decreases depending on the position in the circumferential direction. A convex engaging portion 46c or a trough 46i is formed between two adjacent sloped portions 46h so as to alternate.

[Reverse Rotation Prevention Mechanism]

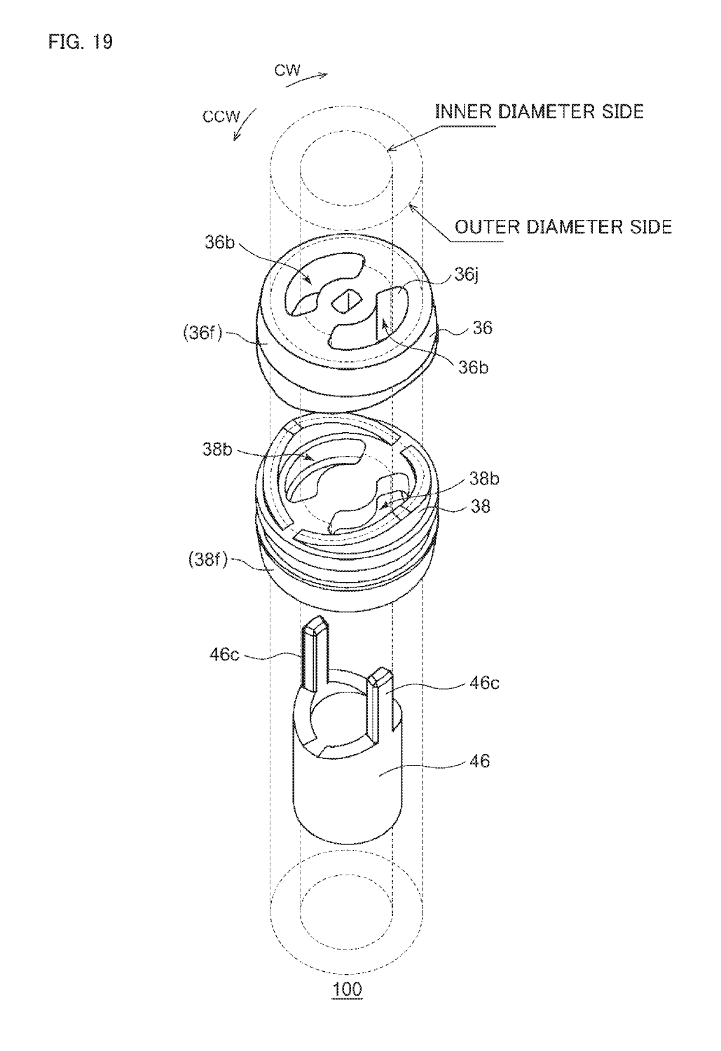

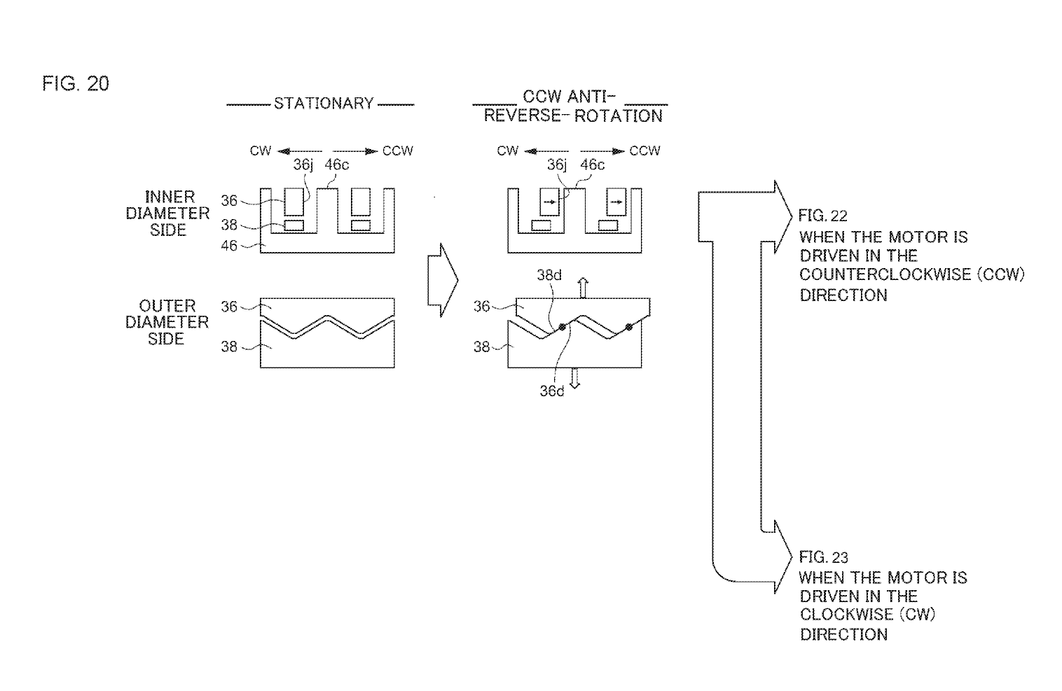

FIG. 19 is an exploded perspective view of an important part of the reverse rotation prevention mechanism 100 according to reference example 1. FIG. 20 is a schematic diagram illustrating how the components work when an external force in the rotational direction is exerted on the output shaft. FIG. 20 is a schematic sectional development view of the inner diameter side and outer diameter side of the reverse rotation prevention mechanism of FIG. 19.

As shown in FIG. 20, when the motor 10 with a reducer is stationary, the convex engaging portion 46c of the output pin 46 is not in contact with the output plate 36 or the lock plate 38 in the through hole 36b of the output plate 36 and in the through hole 38b of the lock plate 38. In this case, no large forces are exerted between the components.

A description will now be given of a case where an external force is exerted on the output shaft in the stationary state like this and the output plate 36 is rotated in, for example, the counterclockwise direction (CCW). When the output plate 36 is rotated in the counterclockwise direction, the inner wall 36j of the through hole 36b of the output plate 36 approaches the convex engaging portion 46c of the output pin 46 on the inner diameter side. In other words, the output plate 36 could be rotated on the outer diameter side described later until a force that causes the output plate 36 and the lock plate 38 to be spaced apart from each other in the axial direction is generated. Meanwhile, the sloped portion 36d of the output plate 36 and the sloped portion 38d of the lock plate 38 come into contact with each other on the outer diameter side in association with the rotation of the output plate 36, generating a force that causes the output plate 36 and the lock plate 38 to be spaced apart from each other in the axial direction.

FIG. 21 is a schematic diagram illustrating how the reverse rotation prevention mechanism works when an external force in the rotational direction is exerted on the output shaft. The through hole 36a of the output plate 36 and a D cut portion 26a at the end of the gear side shaft 26 in the reverse rotation prevention mechanism 100 are shaped so as to permit the axial movement of the output plate 36 relative to the gear side shaft 26 and restrict the rotational movement of the output plate 36 relative to the gear side shaft 26 (prevent relative rotation).

As described with reference to FIG. 20, when a force that causes the output plate 36 and the lock plate 38 to be spaced apart from each other in the axial direction is generated in the reverse rotation prevention mechanism 100 configured as described above, the output plate 36 moves toward the worm 22 and the lock plate 38 moves toward the output pin 46. The brake surface 36f (see FIG. 11) of the output plate 36 is pressed by the brake surface 32c (see FIG. 7) of the output plate side brake member 32 so as to generate a frictional braking force. Further, the brake surface 38f (see FIG. 13) of the lock plate 38 is pressed by the brake surface 42c (see FIG. 15) of the lock plate side brake member 42 so as to generate a frictional braking force. In this way, stable anti-reverse-rotation performance is realized. Consequently, the output shaft 18 is prevented from being rotated in an unintended manner even if an external force is exerted on the output shaft 18.

[Motor Driving]

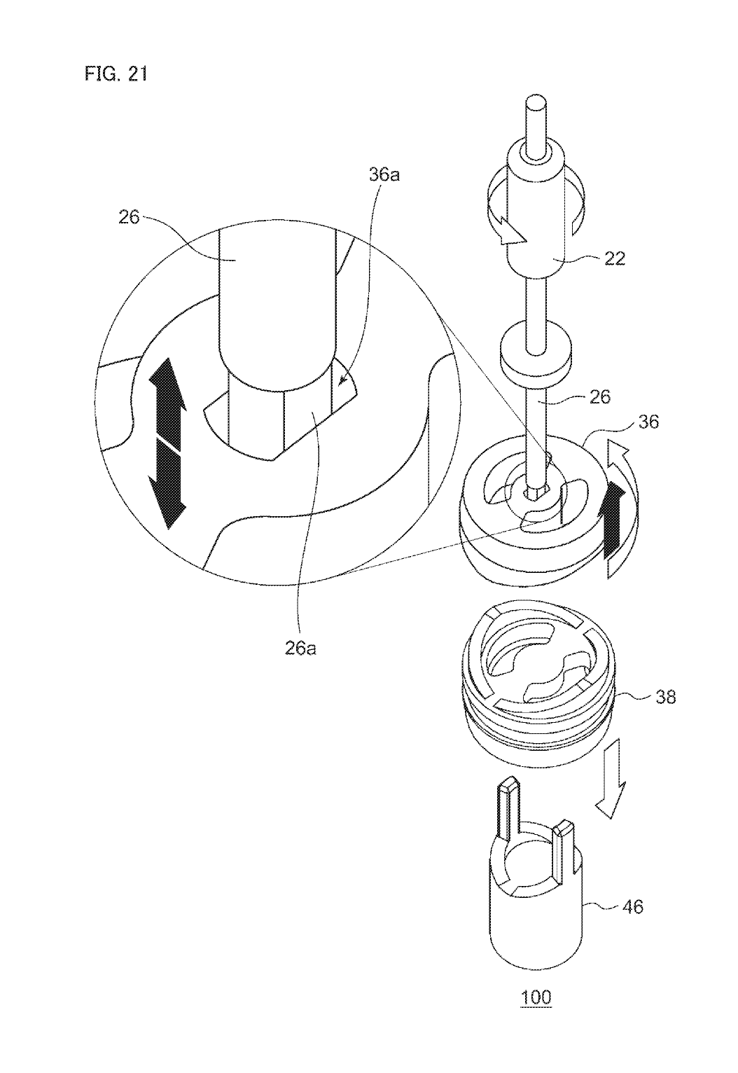

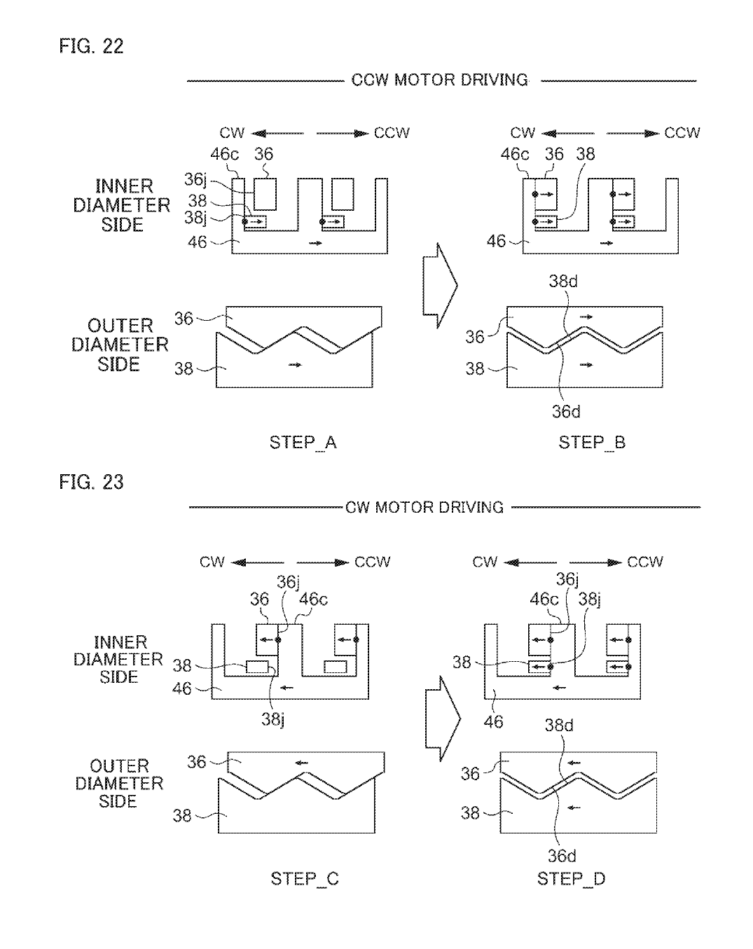

FIG. 22 is a schematic diagram illustrating the action performed when the motor in the state shown in FIG. 20 where the reverse rotation prevention mechanism is functioning is driven in the counterclockwise direction (CCW). FIG. 23 is a schematic diagram illustrating the action performed when the motor in the state shown in FIG. 20 where the reverse rotation prevention mechanism is functioning is driven in the clockwise direction (CW).

When the motor is driven in the counterclockwise direction, the output pin 46 starts rotating and the convex engaging portion 46c of the output pin 46 comes into contact with the inner wall 38j of the through hole 38b of the lock plate 38 as shown in FIG. 22, causing the lock plate 38 to start rotating along with the output pin 46 (STEP_A). As the output pin 46 is rotated further, the convex engaging portion 46c of the output pin 46 comes into contact with the inner wall 36j of the through hole 36b of the output plate 36, causing the output plate 36, as well as the lock plate 38, to be rotated along with the output pin 46 (STEP_B). As a result, the sloped portion 36d of the output plate 36 and the sloped portion 38d of the lock plate 38 are disengaged from each other, eliminating the frictional braking force generated between the output plate 36 and the brake surface 32c and between the lock plate 38 and the brake surface 42c.

Similarly, when the motor is driven in the clockwise direction, the output pin 46 starts rotating and the convex engaging portion 46c of the output pin 46 comes into contact with the inner wall 36j of the through hole 36b of the output plate 36 as shown in FIG. 23, causing the output plate 36 to start rotating along with the output pin 46 (STEP_C). As the output pin 46 is rotated further, the convex engaging portion 46c of the output pin 46 comes into contact with the inner wall 38j of the through hole 38b of the lock plate 38, causing the lock plate 38, as well as the output plate 36, to be rotated along with the output pin 46 (STEP_D). As a result, the sloped portion 36d of the output plate 36 and the sloped portion 38d of the lock plate 38 are disengaged from each other, eliminating the frictional braking force generated between the output plate 36 and the brake surface 32c and between the lock plate 38 and the brake surface 42c.

As shown in FIGS. 22 and 23, the reverse rotation prevention mechanism according to the embodiment is configured such that the frictional braking force generated when an external force in the rotational direction is exerted on the output shaft is eliminated during ordinary motor operation so that reduction in the transmission efficiency of motor torque due to frictional resistance is prevented.

[Prevention of Co-Rotation in Anti-Reverse-Rotation Mode]

As described with reference to FIG. 20, when an external force is exerted on the output shaft, the output plate 36 is rotated in, for example, the counterclockwise direction and displaced in rotational phase from the lock plate 38, causing the sloped portion 36d of the output plate 36 to come into contact with the sloped portion 38d of the lock plate 38 and generating a force that causes the output plate 36 and the lock plate 38 to be spaced apart from each other. However, if the frictional coefficient at a surface of contact of the sloped portion 36d of the output plate 36 and the sloped portion 38d of the lock plate 38 is large, the sloped portion 36d of the output plate 36 coming into contact with the sloped portion 38d of the lock plate 38 during the counterclockwise rotation no longer slides. In this case, the plates are co-rotated with the sloped portions 36d and 38d of the output plate 36 and the lock plate 38 remaining in contact with each other. In this case, the output plate 36 and the lock plate 38 are not displaced further relative to each other in rotational phase, so that a force that causes the output plate 36 and the lock plate 38 to be spaced apart from each other in the axial direction is not generated and a frictional braking force is not generated.

To address the issue, the reverse rotation prevention mechanism 100 according to reference example 1 is configured such that the O-ring 40 is fitted to the groove 38i formed in the outer circumferential surface of the lock plate 38 and inserted into the sleeve 34 (see FIG. 4, etc.). Due to the frictional resistance between the lock plate 38 and the O-ring 40 and the frictional resistance between the O-ring 40 and the sleeve 34, a force that maintains the lock plate 38 in its place is exerted, preventing the lock plate 38 from being co-rotated with the rotation of the output plate 36.

[Shape of Frictional Surface]

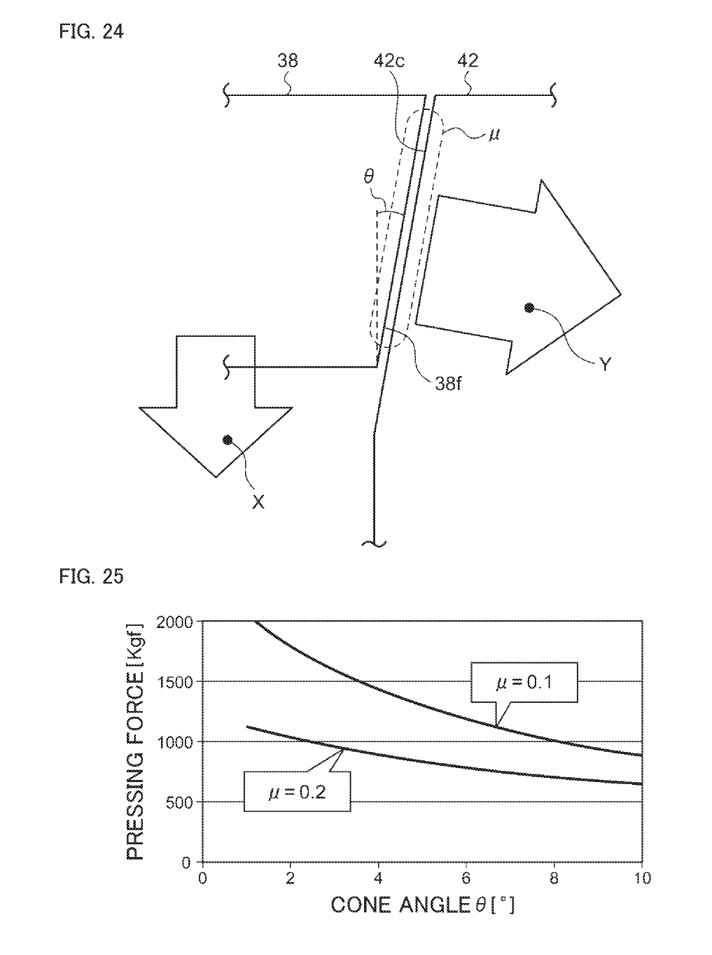

FIG. 24 is a schematic diagram illustrating a frictional force generation unit according to reference example 1.

FIG. 25 shows a relationship between a cone angle θ and a pressing force Y.

The brake surface 38f of the lock plate 38 in the reverse rotation prevention mechanism 100 according to the embodiment is a surface tapered with respect to the axial direction (the direction of the central axis of the lock plate 38) of the gear side shaft 26. The brake surface 42c of the lock plate side brake member 42 is also a tapered surface. The cone (gradient) angle θ shown in FIGS. 24 and 25 is an angle formed between the axial direction and the brake surface and is half as large as the taper angle formed by the opposite brake surfaces 38f of the lock plate 38.

As shown in FIG. 24, when an axial force from the output plate 36 is exerted on the lock plate 38, the lock plate side brake member 42 receives the pressing force Y from the lock plate 38 in the direction indicated by the arrow. Thus, the brake surface 38f of the lock plate 38 can generate the pressing force Y in a direction different from the direction in which the lock plate 38 is pressed. Given the axial force X, cone angle θ, and frictional coefficient μ described later, the pressing force Y is given by

Y=X/(μ cos θ+sin θ) (1).

Denoting the frictional coefficient between the brake surface 38f and the brake surface 42c by μ, it will be appreciated that the smaller the cone angle and the smaller the frictional coefficient μ, the larger the pressing force Y and the gain (Y/X) of the pressing force Y with respect to the axial force X, as shown in FIG. 25. Accordingly, the cone angle θ is established as appropriate, allowing for the pressing force, frictional coefficient, gain, etc. to prevent reverse rotation. It is desired that the taper angle of the brake surface 38f of the lock plate 38 be not less than 1° and less than 30° (the cone angle is not less than 0.5° and less than 15°). Further, it is desired that the frictional coefficient be in a range 0.01-0.8. This ensures that a large pressing force Y is generated.

As described above, the reverse rotation prevention mechanism 100 according to reference example 1 is provided on a torque transmission path between the output shaft 18 and the driving shaft 20 of the motor. The reverse rotation prevention mechanism 100 is provided with a first frictional force generation unit configured to inhibit the rotation of the lock plate 38 (braking rotational member) provided on the torque transmission path relative to the first casing 28 when an external force in the rotational direction is exerted on the output shaft 18 and when the motor is driven, and a second frictional force generation unit configured to generate a braking force for preventing reverse rotation as a result of the brake surface 38f of the lock plate 38 being pressed when an external force in the rotational direction is exerted on the output shaft 18.

The first frictional force generation unit according to reference example 1 is comprised of the sleeve 34 and the O-ring 40 and is provided between the first casing 28 (non-rotating fixed member) and the lock plate 38. This makes it difficult for the lock plate 38 to move relative to the first casing 28 and inhibits the lock plate 38 from co-rotating with the output plate 36 (another rotating body) when an external force is exerted on the output shaft 18. By selecting the material and shape of the first casing 28 and the O-ring 40 properly, the sleeve 34 may be omitted.

The second frictional force generation unit according to reference example 1 is comprised of the brake surface 42c of the lock plate side brake member 42 and the brake surface 38f of the lock plate 38. In the reverse rotation prevention mechanism 100, the first frictional force generation unit is provided in an area different from that of the second frictional force generation unit.

This makes it possible to configure the brake surface 42c primarily to generate a braking force for preventing reverse rotation. In other words, a material capable of generating high frictional resistance can be employed. Meanwhile, the O-ring 40 of the first frictional force generation unit can be primarily configured to inhibit the rotation of the lock plate 38 relative to the first casing 28. In other words, the O-ring 40 is enabled for controlling the frictional resistance between the O-ring 40 and the sleeve 34 to a relatively small magnitude sufficient to prevent the co-rotation of the lock plate 38 with the rotation of the output plate 36. This can reduce the sliding resistance between the O-ring 40 and the sleeve 34 when the motor is driven and minimizes reduction in the transmission efficiency of driving torque of the motor 12. Further, because a material with low frictional resistance can be used for the O-ring 40, a material with excellent abrasion resistance can be selected.

By providing frictional force generation units with different requirements for frictional force (frictional resistance) in separate areas, optimization and flexibility of design are promoted. For this reason, stable anti-reverse-rotation performance can be maintained for a long period of time.

The reverse rotation prevention mechanism 100 is also provided with a spacing mechanism for causing the brake surface 38f of the lock plate 38 to be spaced apart from the brake surface 42c of the lock plate side brake member 42 when the motor 12 is driven. More specifically, as the sloped portion 46h (see FIGS. 17, FIG. 18) of the output pin 46 comes into contact with the sloped portion 38k (see FIG. 13, FIG. 14) of the lock plate 38 in association with the rotation of the output pin 46, the lock plate 38 is displaced in a direction away from the output pin 46. Accordingly, the brake surface 38f of the lock plate 38 is spaced apart from the brake surface 42c of the lock plate side brake member 42.

As shown in FIGS. 22 and 23, as the output plate 36 and the lock plate 38 are aligned in rotational phase in association with the further rotation of the output pin 46 (see STEP_B of FIG. 22 and STEP_D of FIG. 23), the sloped portion 36d of the output plate 36 and the sloped portion 38d of the lock plate 38 hitherto in contact with each other are disengaged. As a result, the force that causes the output plate 36 and the lock plate 38 from being spaced apart from each other in the axial direction is removed, causing the brake surface 38f of the lock plate 38 to be spaced apart from the brake surface 42c of the lock plate side brake member 42 and causing the brake surface 36f of the output plate 36 to be spaced apart from the brake surface 32c of the output plate side brake member 32. This eliminates the braking force (sliding friction) from the output plate side brake member 32 and the lock plate side brake member 42 when the motor is driven.

Further, the reverse rotation prevention mechanism 100 is provided with the output plate 36 (braking and pressing member) configured to be spaced apart from the lock plate 38 due to a reactive force responsive to the force that presses the lock plate 38 against the brake surface 42c of the lock plate side brake member 42 when an external force is exerted on the output shaft 18, and with a second braking force generation unit configured to generate a braking force for preventing reverse rotation by causing the brake surface 36f of the output plate 36 to be pressed when an external force is exerted on the output shaft 18. The second braking force generation unit is comprised of the brake surface 36f of the output plate 36 and the brake surface 32c of the output plate side brake member 32. By generating a braking force in a plurality of frictional force generation units in this way, a larger frictional braking force is obtained than when a braking force is generated in a single frictional force generation unit and stable anti-reverse-rotation performance is realized.

### REFERENCE EXAMPLE 2

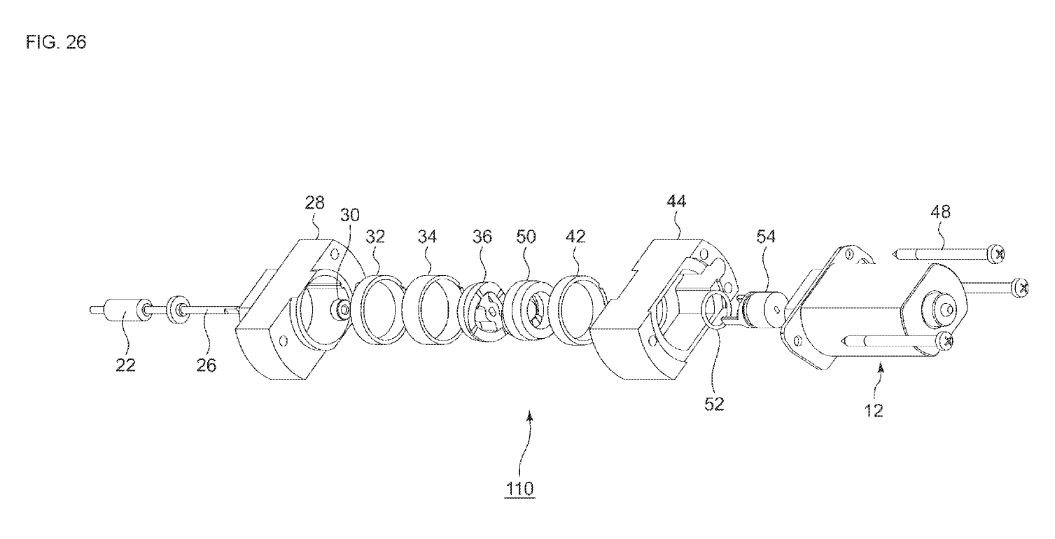

FIG. 26 is an exploded perspective view of a reverse rotation prevention mechanism 110 according to reference example 2.

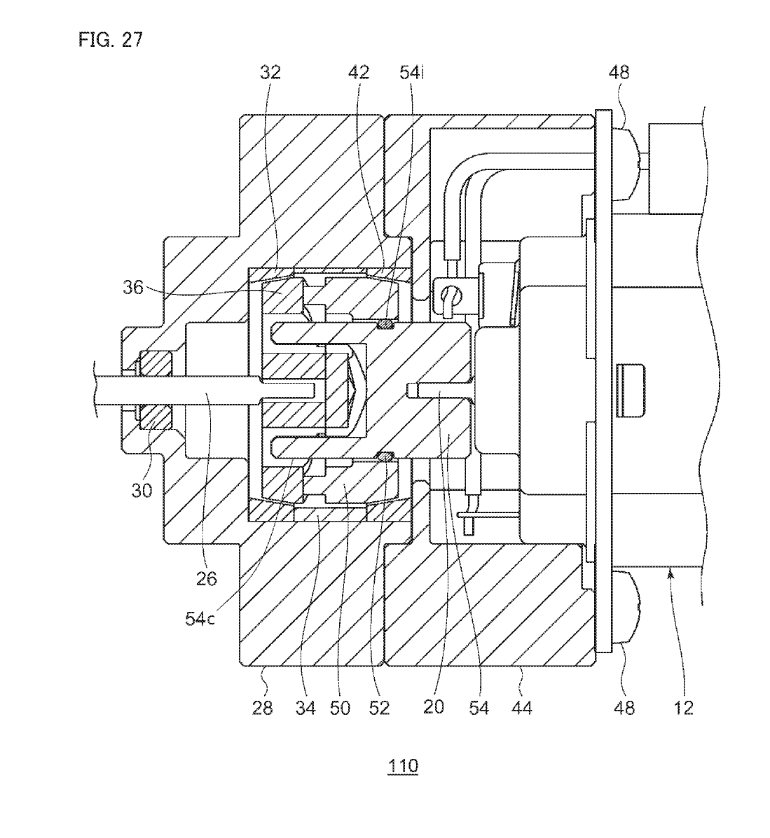

FIG. 27 is an enlarged sectional view of the neighborhood of the reverse rotation prevention mechanism according to reference example 2.

The reverse rotation prevention mechanism 110 according to reference example 2 differs from the reverse rotation prevention mechanism 100 according to reference example 1 in respect of the position of the first frictional force generation unit. More specifically, an O-ring is not fitted on the outer circumferential surface of a lock plate 50. Instead, an O-ring 52 is fitted to the outer circumferential surface (a groove 54i) of an output pin 54.

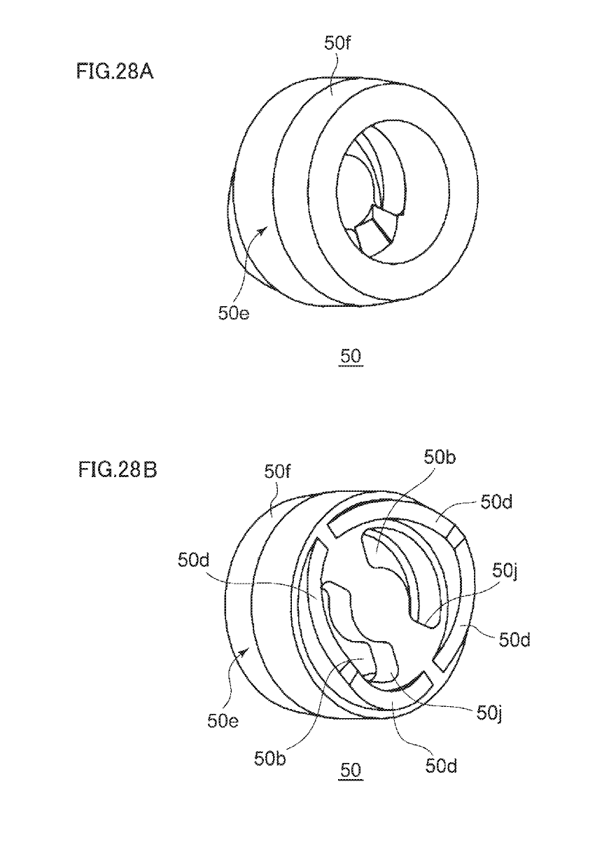

FIG. 28A is a perspective view of a lock plate 50 according to reference example 2, and FIG. 28B is a perspective view of the lock plate 50 viewed from a direction different from that of FIG. 28A. A portion of an outer circumferential surface 50e of the lock plate 50 functions as a brake surface 50f. The outer circumferential surface 50e is not formed with a groove to which an O-ring is fitted. In the other respects, the lock plate 50 and the lock plate 38 of reference example 1 are identically shaped.

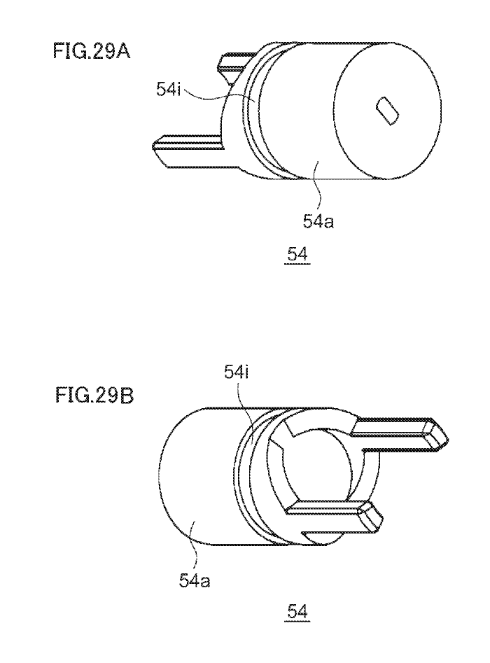

FIG. 29A is a perspective view of the output pin 54 according to reference example 2, and FIG. 29B is a perspective view of the output pin 54 viewed from a direction different from that of FIG. 29A. The groove 54i to which the O-ring 52 is fitted is formed on the outer circumferential surface of a cylindrical main unit 54a of the output pin 54.

In the other respects, the output pin 54 and the output pin 46 of reference example 1 are identically shaped. The output pin 54 is a driving shaft side rotational member provided on the torque transmission path more toward the driving shaft 20 of the motor than the lock plate 50.

In the reverse rotation prevention mechanism 110 according to reference example 2, the output pin 54 is engaged with the lock plate 50 and rotated together when the motor is driven as in reference example 1. As shown in FIGS. 26 and 27, the first frictional force generation unit in the reverse rotation prevention mechanism 110 is comprised of the O-ring 52 provided between the lock plate 50 and the output pin 54. This makes it difficult for the lock plate 50 to move relative to the output pin 54 and inhibits the co-rotation of the lock plate 50 and the output plate 36 when an external force in the rotational direction is exerted on the output shaft. The frictional resistance between the members is established as appropriate, allowing for the cogging torque, frictional resistance in the gear unit, frictional resistance in the shaft, etc.

When the motor is driven, the output pin 54 and the lock plate 50 are rotated together so that no frictional resistance is generated due to the O-ring 52 and the transmission efficiency of motor driving torque is prevented from dropping.

### First Embodiment

According to the present invention, stable anti-reverse-rotation performance is realized in the reverse rotation prevention mechanisms according to reference examples 1 and 2. It became clear, however, that the reverse rotation prevention mechanisms, and, in particular, the reverse rotation prevention mechanism according to reference example 2, that there is room for improvements as a result of our further study.

A description will be given of a phenomenon that occurs in the reference rotation prevention mechanism according to reference example 2 in a particular situation. More specifically, when an external force in a direction (e.g., CCW rotation) opposite to that of the motor is exerted on the output plate 36 as the motor in rotation (e.g., CW rotation) is stopped, sufficient resistance to reverse rotation may not be exhibited.

As shown in FIG. 27, the O-ring 52 is fitted in the annular groove 54i formed on the outer circumferential surface of the output pin 54 of the reverse rotation prevention mechanism 110 according to reference example 2. The O-ring 52 is sandwiched between the output pin 54 and the lock plate 50 and generates a frictional force all while the output pin 54 and the lock plate 50 are rotated relative to each other. In other words, the O-ring 52 generates a force that causes one of the output pin 54 and the lock plate 50 to co-rotate with the other in rotation.

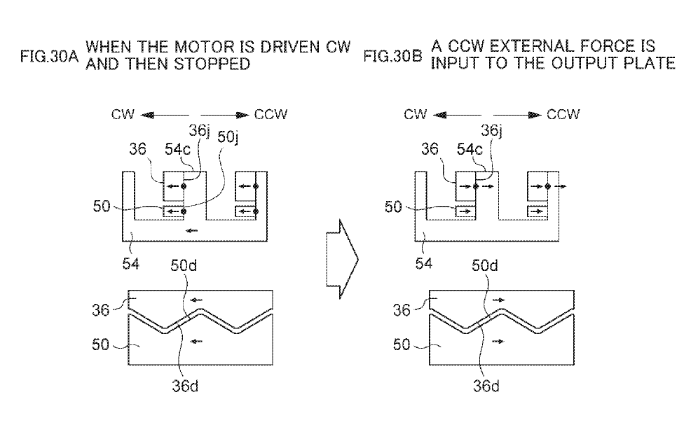

FIG. 30A is a schematic diagram illustrating the action performed since the motor with a reducer provided with the reverse rotation prevention mechanism 110 shown in reference example 2 is driven in the clockwise direction until the motor is stopped; and FIG. 30B is a schematic diagram illustrating the action performed when an external force in the counterclockwise direction is input to the output plate 36 in the state shown in FIG. 30A.

As shown in FIG. 30A, when the motor is driven in the clockwise direction, the output pin 54 is rotated and a convex engaging portion 54c (see FIG. 27) of the output pin 54 comes into contact with the inner wall 36j of the through hole 36b of the output plate 36, causing the output plate 36 to be rotated along with the output pin 54. Similarly, as the output pin 54 is rotated, the convex engaging portion 54c of the output pin 54 comes into contact with an inner wall 50j (see FIG. 28) of a through hole 50b (see FIG. 28) of the lock plate 50, causing the lock plate 50, as well as the output plate 36, to be rotated along with the output pin 54. As a result, the sloped portion 36d of the output plate 36 and a sloped portion 50d (see FIG. 28) of the lock plate 50 are disengaged from each other during rotation, preventing the frictional braking force from being generated between the output plate 36 and the brake surface 32c and between the lock plate 50 and the associated brake surface. When the motor is stopped subsequently, the output plate 36 and the lock plate 50 are stopped, maintaining the state occurring while the motor is being driven (FIG. 30A).

When a counterclockwise external force is input to the output plate 36 via the gear side shaft 26, the inner wall 36j presses the convex engaging portion 54c of the output pin 54, causing the output pin 54 to be rotated in the counterclockwise direction along with the output plate 36. The O-ring 52 is fitted between the output pin 54 and the lock plate 50 in the reverse rotation prevention mechanism 110 and a frictional force is generated between the output pin 54 and the lock plate 50 so that the lock plate 50 is co-rotated as the output pin 54 is rotated (see FIG. 30B). In other words, the output plate 36 and the lock plate 50 are maintained at relative positions shown in FIG. 30A occurring before the external force is input to the output plate 36. The sloped portion 36d and the sloped portion 50d do not come into contact with each other and are rotated, maintaining a disengaged state. Since the output plate 36 and the lock plate 50 do not come into contact with each other and a force that causes the output plate 36 and the lock plate 50 to be spaced apart from each other is not generated, a frictional braking force is not generated so that resistance to reverse rotation cannot be obtained.

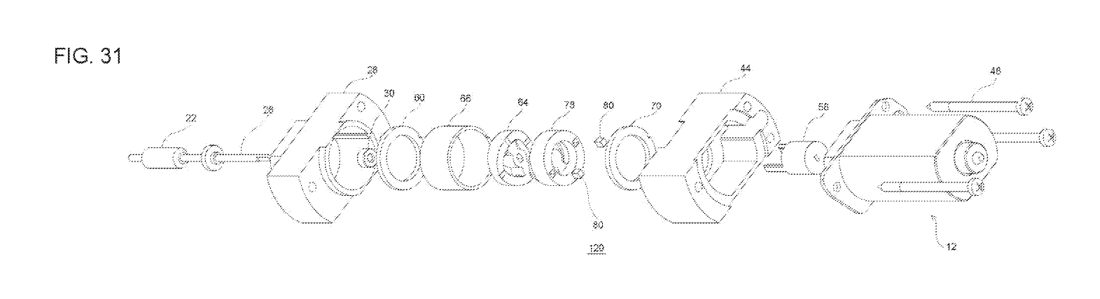

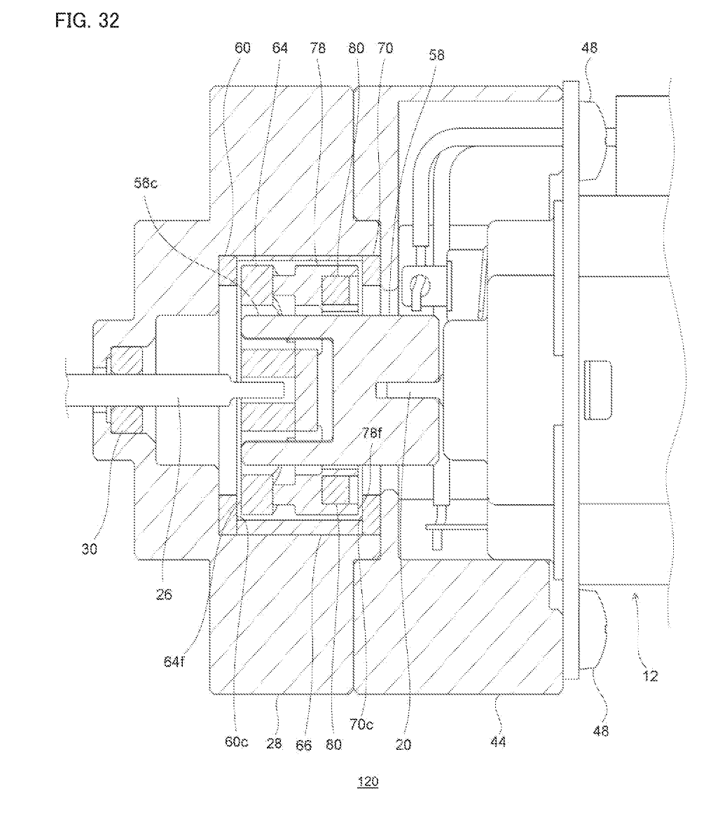

We have devised a novel reverse rotation prevention mechanism that addresses this issue. FIG. 31 is an exploded perspective view of the reverse rotation prevention mechanism 120 according to the first embodiment. FIG. 32 is an enlarged sectional view of the neighborhood of the reverse rotation prevention mechanism according to the first embodiment.

Like the reverse rotation prevention mechanism 110 according to reference example 2, a reverse rotation prevention mechanism 120 according to the first embodiment includes a first casing 28, a sintered bearing 30, and a second casing 44. Meanwhile, the reverse rotation prevention mechanism 120 differs from the reverse rotation prevention mechanism 110 according to reference example 2 in respect of the shape and structure of an output plate side brake member 60, a sleeve 66, an output plate 64, a lock plate 78, a magnet 80, a lock plate side brake member 70, and an output pin 58.

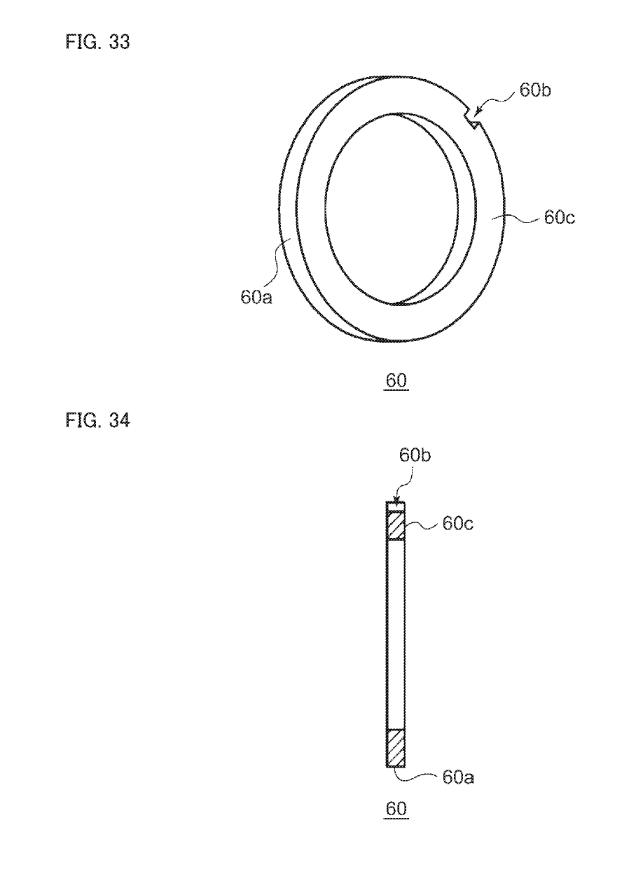

FIG. 33 is a perspective view of the output plate side brake member 60 according to the first embodiment. FIG. 34 is a sectional view of the output plate side brake member 60 according to the first embodiment. The output plate side brake member 60 is an annular member and the inner and outer diameters thereof are uniform. An outer circumferential surface 60a is formed with a groove-like anchoring recess 60b parallel to the axial direction. One end face of the output plate side brake member 60 is a brake surface 60c.

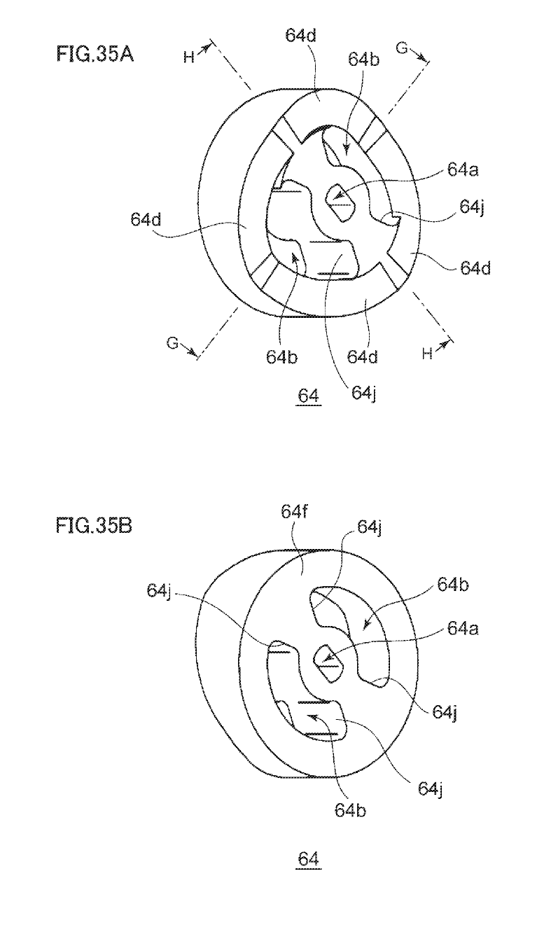

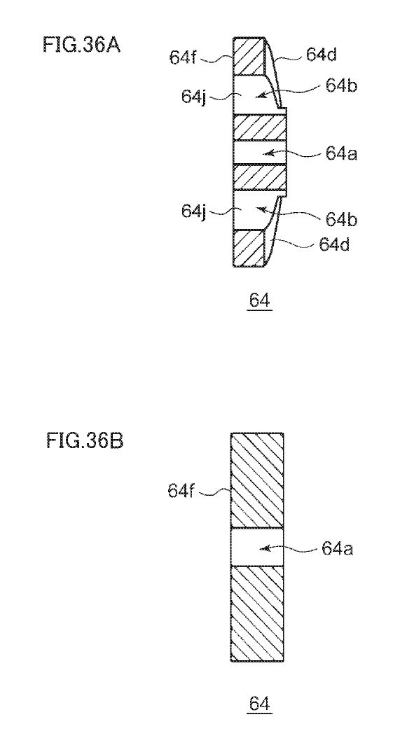

FIG. 35A is a perspective view of the output plate 64 according to the first embodiment, and FIG. 35B is a perspective view of the output plate 64 viewed from a direction different from that of FIG. 35A. FIG. 36A is a sectional view along G-G of the output plate 64 shown in FIG. 35A, and FIG. 36B is a sectional view along H-H of the output plate 64 shown in FIG. 35A.

The output plate 64 is a cylindrical member and differs from the output plate 36 according to reference example 1 in the shape of the brake surface. The output plate 64 is formed at the center with a through hole 64a in which the gear side shaft 26 is inserted. Further, the neighborhood of the center formed with the through hole 64a is formed with two arc-like through holes 64b configured such that output pin 58 rotatable in both directions around the rotational axis when portions of the output pin 58 advance into the through holes 64b. The flat surface of the output plate 64 facing the output plate side brake member 60 is a brake surface 64f. In the other respects, the output plate 64 and the output plate 36 are essentially identically shaped.

The second braking force generation unit in the reverse rotation prevention mechanism 120 according to the first embodiment is implemented by the brake surface 60c of the output plate side brake member 60 pressed by the brake surface 64f of the output plate 64 when an external force is exerted on the output shaft 18. This generates a frictional braking force for preventing reverse rotation.

The sleeve 66 is identical to the sleeve 34 according to reference example 2 except for the thickness in the axial direction. The output pin 58 is not provided with the sloped portion 46h found in the output pin 46 according to reference example 1. The outer circumference of the output pin 58 is not fitted with an O-ring for generating a frictional force against the lock plate 78. This is in contrast with the reverse rotation prevention mechanism 110 according to reference example 2, in which the lock plate 50 in contact with the O-ring 52 is co-rotated as the output pin 54 is rotated.

The other aspects of the shape of the output pin 58 are the same as those of the output pin 46 except that at least a portion of the output pin 58 corresponding to the convex engaging portion 46c is comprised of a magnetic material. This can generate a magnetic attractive force between a convex engaging portion 58c of the output pin 58 and the magnet 80 accommodated in the lock plate 78 described later. In order to generate a magnetic attractive force more efficiently, the magnetic material forming the convex engaging portion 58c is desirably a soft material and, more desirably, iron or iron alloy.

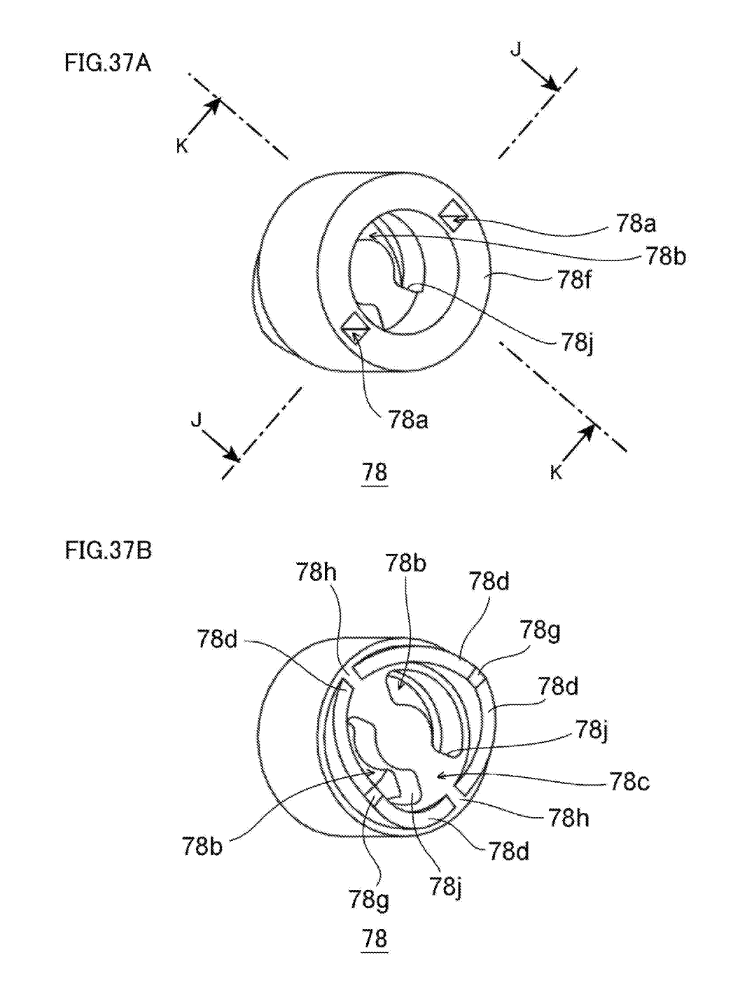

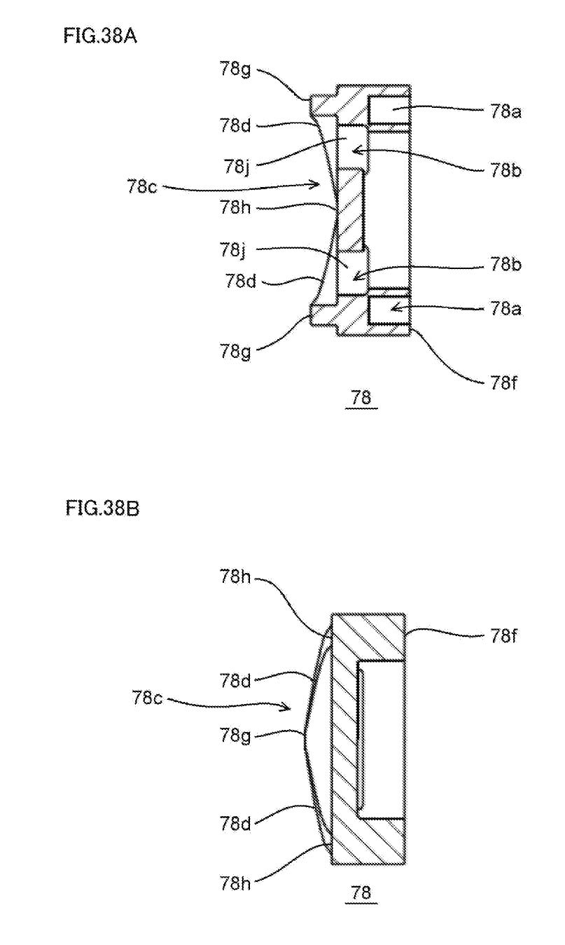

FIG. 37A is a perspective view of a lock plate 78 according to the first embodiment, and FIG. 37B is a perspective view of the lock plate 78 viewed from a direction different from that of FIG. 37A. FIG. 38A is a sectional view along J-J of the lock plate 78 shown in FIG. 37A, and FIG. 38B is a sectional view along K-K of the lock plate 78 shown in FIG. 37A.

The lock plate 78 is a cylindrical member. The neighborhood of the center thereof is formed with two arc-like through holes 78b such that the output pin 58 is rotatable in both directions around the rotational axis when portions of the output pin 58 advance into the through holes 78b. The through hole 78b has an inner wall 78j that comes into contact with a portion of the output pin 58 when the output pin 58 is rotated. An end face 78c of the lock plate 78 that faces the output plate 64 has four arc-like sloped portions 78d formed on the outer circumference of the lock plate 78 in the circumferential direction. The sloped portion 78d is configured such that the height thereof in the axial direction gradually increases or decreases depending on the position in the circumferential direction. A peak 78g or a trough 78h is formed between two adjacent sloped portions 78d.

Four sloped portions 38k that form a spacing mechanism for causing the lock plate 78 to be spaced apart from the lock plate side brake member, such as those formed in the lock plate 38, are not formed between two through holes 78b. For this reason, a force that causes the lock plate 78 to be spaced apart from the output pin 58 is not generated in the reverse rotation prevention mechanism 120 according to the first embodiment even if the output pin 58 is rotated. Unlike the reverse rotation prevention mechanism 100 according to reference example 1, a brake surface 78f of the lock plate 78 described later and a brake surface 70c of the lock plate side brake member 70 are configured to come into contact with each other at respective flat surfaces (not tapered surfaces). Therefore, when the motor is driven while the two brake members are pressed into contact with each other to generate a frictional braking force, the two brake surfaces can be spaced apart from each other easily in the absence of a spacing mechanism. The lock plate 78 differs from the lock plate 38 in that the outer circumferential surface of the cylindrical body thereof is not formed with a groove to which an O-ring is fitted.

The lock plate 78 differs from the lock plate 38 according to reference example 1 in the shape of the brake surface. The flat surface of the lock plate 78 facing the lock plate side brake member 70 is a brake surface 78f. The brake surface 78f is formed with a plurality of (two) magnet holders 78a in which the magnet 80 is inserted and held. By inserting and securing the magnet 80 in the magnet holder 78a, the magnet 80 is inhibited from being dislocated even if the lock plate 78 is rotated at a high speed. Further, the lock plate 78 is formed by a non-magnetic material such as resin.

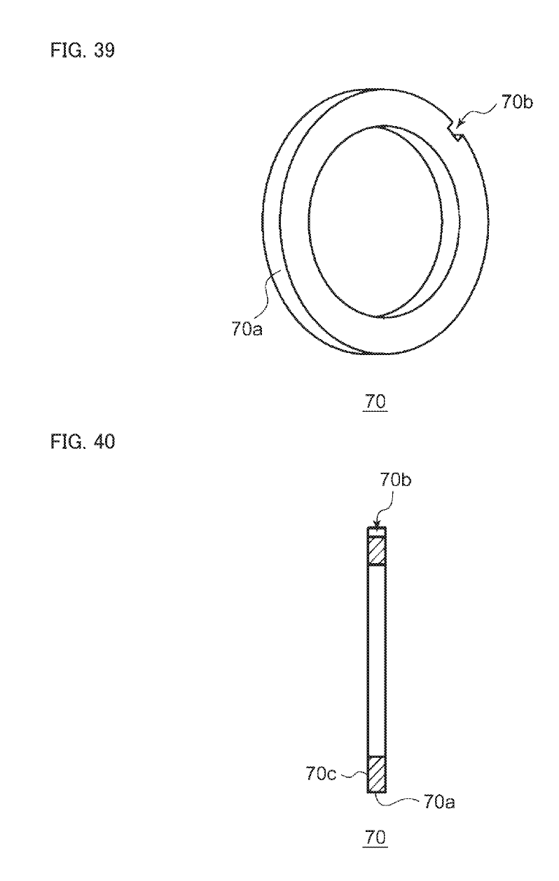

FIG. 39 is a perspective view of the lock plate side brake member 70 according to the first embodiment.

FIG. 40 is sectional view of the lock plate side brake member 70 according to the first embodiment. The lock plate side brake member 70 is an annular member and the inner and outer diameters thereof are uniform. An outer circumferential surface 70a is formed with a groove-like anchoring recess 70b parallel to the axial direction. One end face of the lock plate side brake member 70 is a brake surface 70c.

The first frictional force generation unit in the reverse rotation prevention mechanism 120 according to the first embodiment is implemented by the brake surface 78f of the lock plate 78 pressed by the brake surface 70c of the lock plate side brake member 70 when an external force is exerted on the output shaft 18. This generates a frictional braking force for preventing reverse rotation.

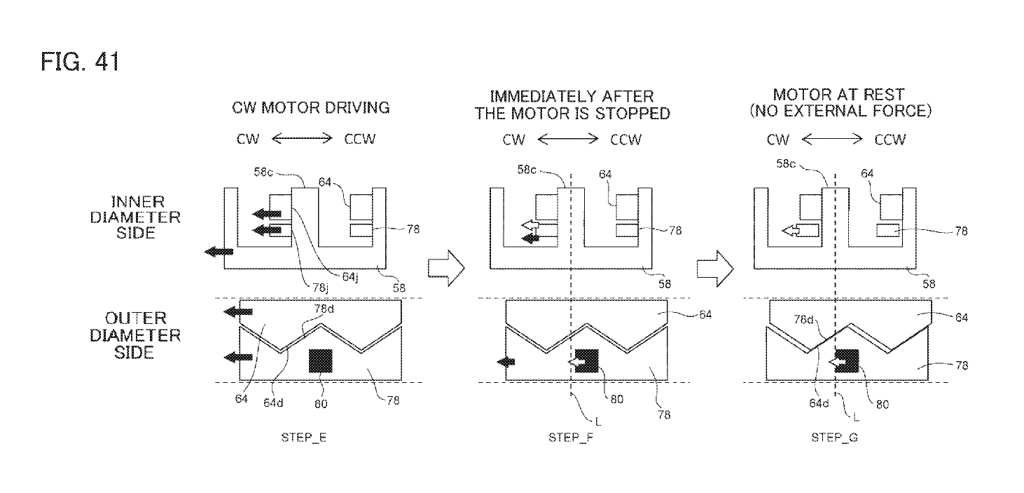

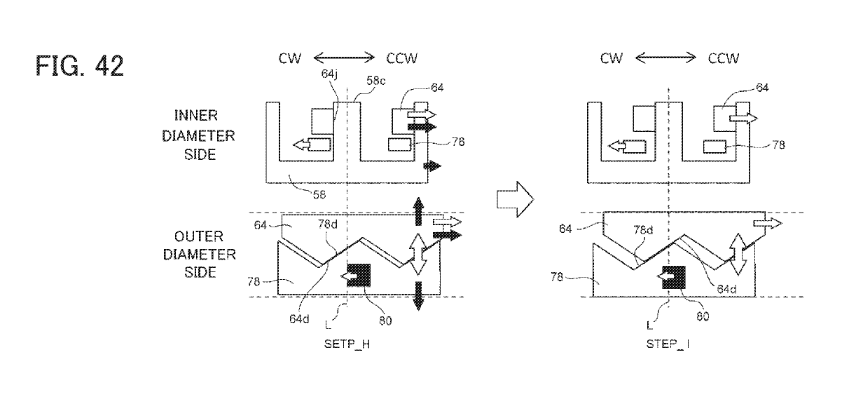

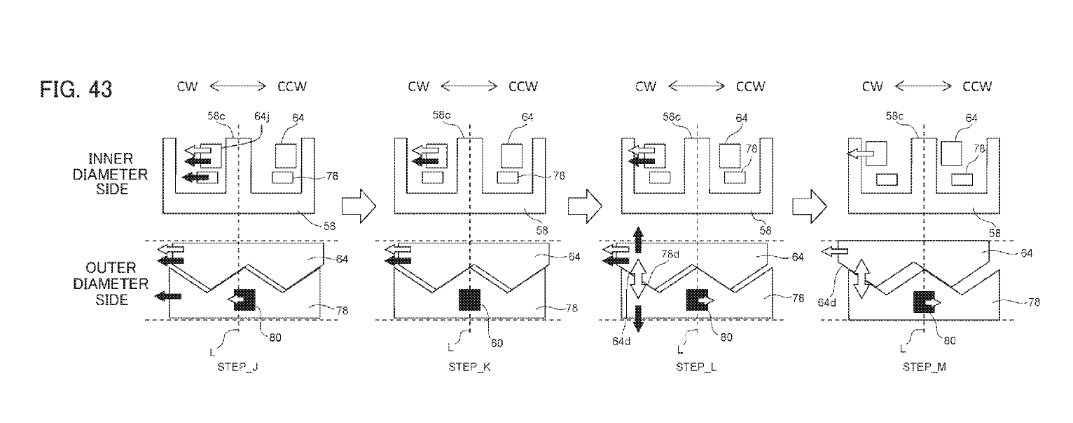

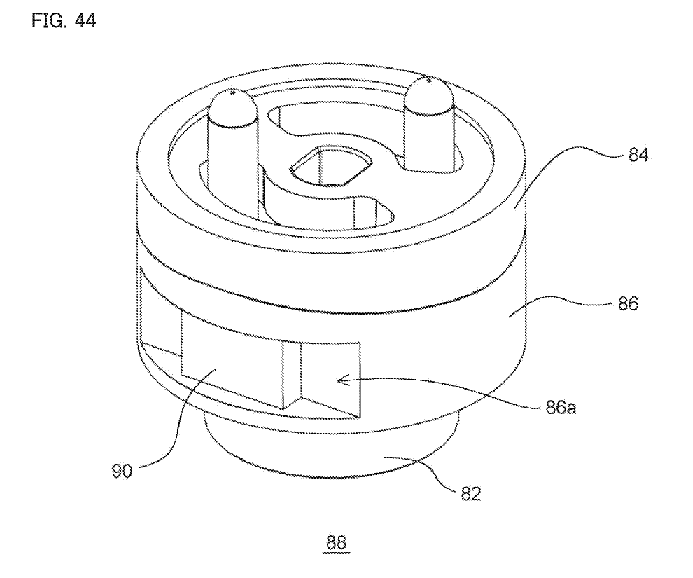

A description will be given of the operation of the reverse rotation prevention mechanism 120 according to the first embodiment. FIG. 41 is a schematic diagram illustrating the action performed since the motor provided with the reverse rotation prevention mechanism 120 according to the first embodiment is driven in the clockwise direction (CW) until the motor is stopped. FIG. 42 is a schematic diagram illustrating the action of the reverse rotation prevention mechanism performed when an external force in the counterclockwise direction is input to the output plate in the state shown in FIG. 41 in which the motor is at rest; FIG. 43 is a schematic diagram illustrating the action of the reverse rotation prevention mechanism performed when an external force in the clockwise direction is input to the output plate in the state shown in FIG. 41 in which the motor is at rest. Solid arrows in the figures denote the movement of the respective members and blank arrows denote major forces exerted on the respective members.

As the motor is rotated in the clockwise rotation, the output pin 58 coupled to the driving shaft 20 is rotated so that an inner wall 64j (see FIG. 35) of the through hole 64b of the output plate 64 and the convex engaging portion 58c of the output pin 58 come into contact with each other and the output plate 64 is rotated along with the output pin 58. Similarly, as the output pin 58 is rotated further, the convex engaging portion 58c of the output pin 58 comes into contact with the inner wall 78j of the through hole 78b of the lock plate 78, causing the lock plate 78, as well as the output plate 64, to be rotated along with the output pin 58 (STEP_E). As a result, a sloped portion 64d (see FIG. 35) of the output plate 64 and the sloped portion 78d of the lock plate 78 are disengaged from each other during rotation, preventing the frictional braking force from being generated between the output plate 64 and the brake surface 60c and between the lock plate 78 and the brake surface 70c.

When the motor is stopped subsequently, the output plate 64 and the lock plate 78 are also stopped, maintaining the state of STEP_E. The magnetic attractive force continues to be exerted between the convex engaging portion 58c formed by a magnetic material and the magnet 80 (STEP_F). A dotted line L indicates a position where the convex engaging portion 58c and the magnet 80 establish a balance naturally in the presence of a magnetic attraction force when the output pin 58, the output plate 64 and the lock plate 78 are assembled. The convex engaging portion 58c and the magnet 80 attract each other by a magnetic attraction force. The convex engaging portion 58c coupled to the driving shaft 20 of the motor will remain in its place due to a cogging torque (a force that causes the rotor to remain in its place due to the relative magnetic positions of the rotor and the stator of the motor at rest) that is greater than the magnetic attraction force. Therefore, the magnet 80 will move in the direction of the convex engaging portion 58c.

Accordingly, a force that attracts the magnet 80 to a position denoted by the dotted line L is exerted so that only the lock plate 78 accommodating the magnet 80 moves left in the figure. As a result, the lock plate 78 is rotated slightly until the sloped portion 78d of the lock plate 78 comes into contact with (is engaged with) the sloped portion 64d of the output plate 64 and the lock plate 78 is stopped (STEP_G).

Thus, unlike the reverse rotation prevention mechanism 110 according to reference example 2, the reverse rotation prevention mechanism 120 according to the first embodiment is capable of creating engagement between the output plate 64 and the lock plate 78 immediately after the motor is stopped when an external force is not exerted.

A description will be given of a case in which a counterclockwise external force is exerted on the reverse rotation prevention mechanism 120 from the side of the worm 22 in the stationary state shown in STEP_G, with reference to FIG. 42. When a counterclockwise external force is exerted on the output plate 64, the inner wall 64j of the output plate 64 presses the convex engaging portion 58c, causing the output pin 58 to move right in the figure. Meanwhile, the magnet 80 accommodated in the lock plate 78 is attracted by the convex engaging portion 58c so that the lock plate 78 will remain in its place due to a force exerted leftward in the figure.

The resultant movement of the sloped portion 64d of the output plate 64 in contact with the sloped portion 78d of the lock plate 78 generates a force that spaces the output plate 64 and the lock plate 78 apart from each other in the axial direction, causing the output plate 64 to move toward the output plate side brake member 60 and causing the lock plate 78 to move toward the lock plate side brake member 70 (STEP_H).

As the output plate 64 is further rotated, the brake surface 64f of the output plate 64 is pressed by the brake surface 60c of the output plate side brake member 60 so as to generate a frictional braking force, and the brake surface 78f of the lock plate 78 is pressed by the brake surface 70c of the lock plate side brake member 70 so as to generate a frictional braking force (STEP_I). In this way, stable anti-reverse-rotation performance is realized. In other words, the output shaft 18 is prevented from being rotated in an unintended manner even if a counterclockwise external force is exerted on the output shaft 18.

A description will be given of a case in which a clockwise external force is exerted on the reverse rotation prevention mechanism 120 from the side of the worm 22 in the stationary state shown in STEP_G, with reference to FIG. 43.

When a clockwise external force is exerted on the output plate 64, the inner wall 64j of the output plate 64 is spaced apart from the convex engaging portion 58c and moves leftward in the figure. Associated with this, the lock plate 78 also moves leftward in the figure as a result of the magnet 80 being attracted by the convex engaging portion 58c (STEP_J).

As the output plate 64 is further rotated in the clockwise direction, the lock plate 78 is rotated as far as a position (a position denoted by the dotted line L) where the magnet 80 is aligned in phase with the center of the convex engaging portion 58c (STEP_K). If the output plate 64 is further rotated in the clockwise direction, the lock plate 78 is not rotated relative to the output pin 58 due to the action of the magnet 80. The sliding movement of the sloped portion 64d of the output plate 64 on the sloped portion 78d of the lock plate 78 generates a force that spaces the output plate 64 and the lock plate 78 apart from each other in the axial direction, causing the output plate 64 to move toward the output plate side brake member 60 and causing the lock plate 78 to move toward the lock plate side brake member 70 (STEP_L).

As the output plate 64 is further rotated, the brake surface 64f of the output plate 64 is pressed by the brake surface 60c of the output plate side brake member 60 so as to generate a frictional braking force, and the brake surface 78f of the lock plate 78 is pressed by the brake surface 70c of the lock plate side brake member 70 so as to generate a frictional braking force (STEP_M).

The reverse rotation prevention mechanism 120 according to the first embodiment inhibits the rotation of the lock plate 78 in tandem with the output plate 64 in the states of STEP_L and STEP_M, using the magnetic attraction force between the convex engaging portion 58c of the output pin 58 and the magnet 80. Therefore, the output plate 64 and the lock plate 78 can be spaced apart from each other promptly and properly and stable anti-reverse-rotation performance is realized. In other words, the output shaft 18 is prevented from being rotated in an unintended manner even if an external force in the rotational direction is exerted on the output shaft 18.

In the reverse rotation prevention mechanism 120 according to the first embodiment, the brake surface 64f of the output plate 64 is pressed by the brake surface 60c of the output plate side brake member 60, and the brake surface 78f of the lock plate 78 is pressed by the brake surface 70c of the lock plate side brake member 70, thereby generating a frictional braking force at two locations. Depending on the magnitude of frictional braking force required of the application or the structure addressed by the reverse rotation prevention mechanism according to the embodiment, a frictional braking force may be generated at one location.

The external force exerted on the output shaft is exerted on the reverse rotation prevention mechanism according to the first embodiment due to a gear ratio between the worm and the worm wheel so that the strength of the members constituting the reverse rotation prevention mechanism can be reduced.

A description will be given of the material of the output plate side brake member 60, output plate 64, lock plate 78, and lock plate side brake member 70 that slide against other components. If the components that slide against each other are formed by the same material, the components may be fused due to the frictional heat or pressure during the sliding motion. It is therefore desired that mutually sliding components be formed by different materials. It is further desired, in view of the structure and purpose of the reverse rotation prevention mechanism 120, to form the two brake members by a metal, form the output plate 64 and the lock plate 78 by different engineering plastics, and configure the frictional coefficient of the engineering plastic of the output plate 64 to be small than the frictional coefficient of the engineering plastic of the lock plate 78. It is particularly desired to form the two brake members by iron, form the output plate 64 by polyacetal (POM), and form the lock plate 78 by polybutylene terephthalate (PBT).

### Second Embodiment

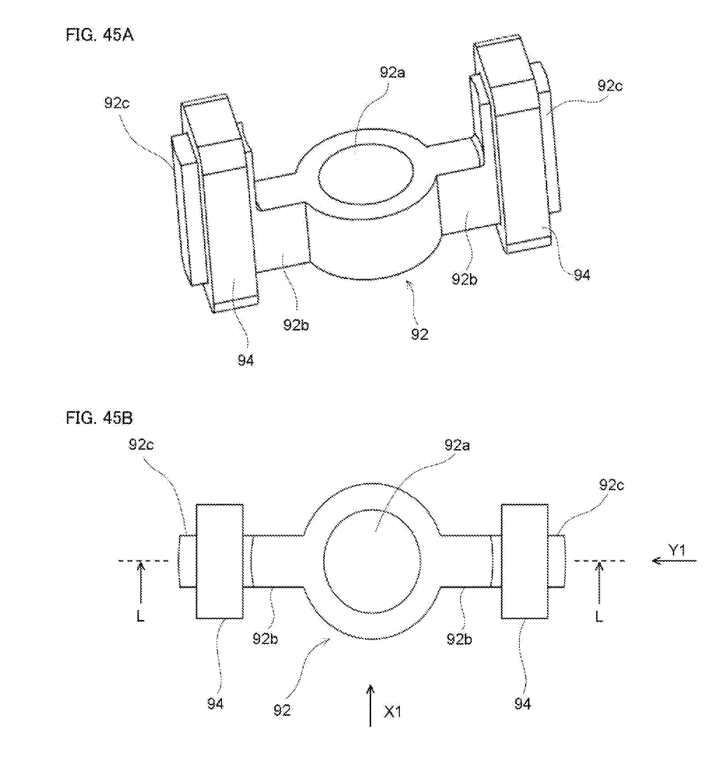

FIG. 44 is a schematic diagram of a unit including a combination of the output pin, output plate, and lock plate according to the second embodiment.

The shape and function of the output pin 82, output plate 84, and lock plate 86 according to the second embodiment are substantially identical to those of the output pin 58, output plate 64, and lock plate 78 used in the reverse rotation prevention mechanism 120 according to the first embodiment. The characteristic of a unit 88 is that a plate-shaped magnet 90 is disposed in an outer circumferential groove 86a of the lock plate 86. This improves the workability of mounting the magnet 90 on the lock plate 86.

The convex engaging portion of the output pin is described as being formed by a magnetic material and the magnet is described as being mounted on the lock plate formed by a non-magnetic material in the first and second embodiments. Alternatively, at least a portion of the output pin may be formed by a magnet and at least a portion of the lock plate may be formed by a magnetic material. Still alternatively, at least a portion of the output pin may be formed by a magnet and at least a portion of the lock plate may be formed by a magnet.

### Third Embodiment

In the foregoing embodiments, contact sound may be produced as the output pin comes into contact with the inner wall of the output plate or the lock plate. In particular, the sound will be large if the convex engaging portion is formed by a magnetic material or a magnet. The user may feel uneasy depending on the application of the motor. A description in the third embodiment will now be given of an output pin designed to reduce sound.

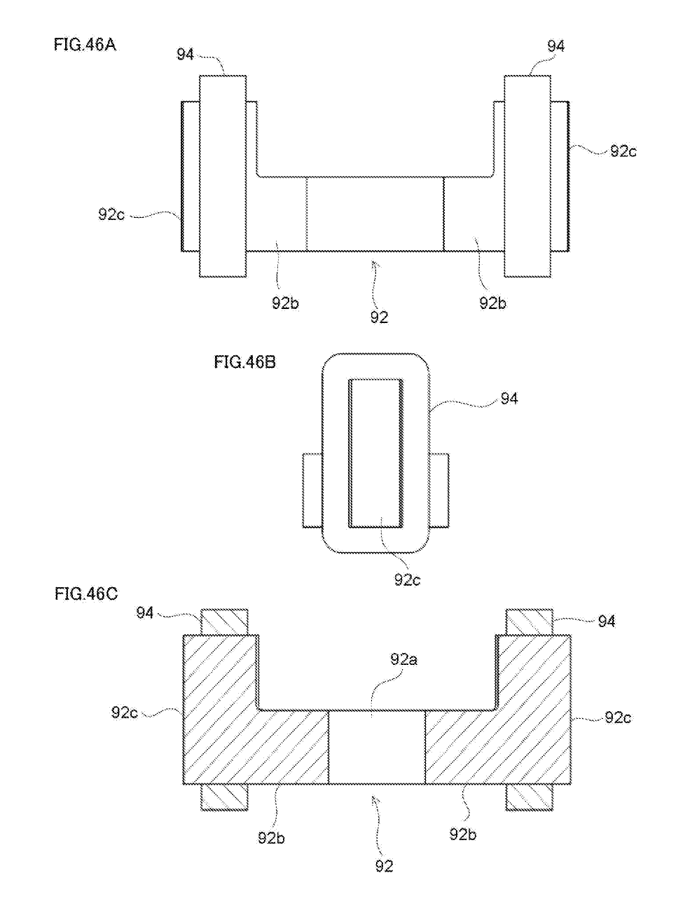

FIG. 45A is a perspective view of the output pin according to the third embodiment, and FIG. 45B is a top view of the output pin shown in FIG. 45A. FIG. 46A is a front view of the output pin shown in FIG. 45B viewed from a direction of arrow X1; FIG. 46B is a side view of the output pin shown in FIG. 45B viewed from a direction of arrow Y1; and FIG. 46C is a sectional view along L-L of the output pin shown in FIG. 45B.

The cylindrical center of an output pin 92 is formed with a press fitting hole 92a in which the driving shaft is press fitted. Two arms 92b are provided to project radially from the cylindrical outer circumference. A convex portion 92c projecting in the axial direction is provided at the end of each arm 92b. A buffer rubber 94 is mounted on the neighborhood of the convex portion 92c.

The buffer rubber 94 is mounted on the output pin 92 according to the third embodiment so that the sound produced as the output pin 92 comes into contact with the inner wall of the output plate or the lock plate is reduced.

The following is a summary of the structure and advantageous effects of the reverse rotation prevention mechanism and the motor with a reducer according to the embodiments.

The reverse rotation prevention mechanism 120 is provided on a torque transmission path between the output shaft 18 and the driving shaft 20 of the motor 12. The reverse rotation prevention mechanism 120 includes a relative rotation inhibition unit configured to inhibit rotation of the lock plate 78 provided on the torque transmission path relative to another member when an external force in the rotational direction is exerted on the output shaft 18, and a first braking force generation unit configured to generate a braking force that prevents reverse rotation of the output shaft 18 by causing a portion of the lock plate 78 to be pressed when an external force in the rotational direction is exerted on the output shaft 18. The relative rotation inhibition unit is provided in an area different from the first braking force generation unit.

In this way, the first braking force generation unit can be primarily configured to generate a braking force that prevents reverse rotation. Meanwhile, the relative rotation inhibition unit can be primarily configured to inhibit rotation of the lock plate 78 relative to another member. By providing the first braking force generation unit and the relative rotation inhibition unit, which are required to provide different functions, at separate areas, optimization and flexibility of design are promoted. For this reason, stable anti-reverse-rotation performance can be maintained for a long period of time.

Another member according to the first embodiment is exemplified by the output pin 58 provided on the torque transmission path more toward the driving shaft of the motor than the lock plate 78. The output pin 58 is engaged with the lock plate 78 and rotated together when the motor is driven. The relative rotation inhibition unit is configured to generate an attractive force between the lock plate 78 and the output pin 58. This makes it difficult for the lock plate 78 to move relative to the output pin 58 and inhibits the co-rotation of the lock plate 78 and the output plate 64 when an external force is exerted on the output shaft 18.

The relative rotation inhibition unit according to the first embodiment is configured to disengage the lock plate 78 and the output pin 58 from each other and to cause the sloped portion 78d of the lock plate 78 to come into contact with (is engaged with) the sloped portion 64d of the output plate 64, when the motor is stopped with the lock plate 78 and the output pin 58 being engaged with each other. This inhibits the lock plate 78 from being co-rotated as the output plate 64 starts to be rotated due to an external force while the motor is at rest.

Further, the relative rotation inhibition unit according to the first embodiment includes the magnet 80 provided in the lock plate 78 and the convex engaging portion 58c provided in the output pin 58 and formed by a magnetic material. The relative rotation inhibition unit is configured to generate a magnetic attraction force between the lock plate 78 and the output pin 58. This can disengage the lock plate 78 and the output pin 58 from each other without providing a complicated mechanism.

Still further, the relative rotation inhibition unit according to the first embodiment applies, when an external force is exerted on the output shaft 18 while the lock plate 78 and the output pin 58 are disengaged, a force that causes the lock plate 78 to be rotated in a direction opposite to the direction that the external force drives the output plate 64 into rotation. This can prevent the lock plate 78 from being co-rotated in association with the rotation of the output plate 64.

The relative rotation inhibition unit according to the first embodiment is also configured to exert, when the lock plate 78 is displaced from a reference position L where the lock plate 78 and the output pin 58 establish a balance in the absence of an external force, a force on the lock plate 78 to return it to the reference position. This can prevent the lock plate 78 from being co-rotated in association with the rotation of the output plate 64 due to the external force.

The reverse rotation prevention mechanism may further include a spacing mechanism like the one described in reference example 1 that spaces a portion of the lock plate 78 from the first braking force generation unit when the motor according to the first embodiment is driven. This removes the braking force from the first braking force generation unit promptly when the motor is driven.

Further, the reverse rotation prevention mechanism according to the first embodiment is provided with the output plate 64 configured to be spaced apart from the lock plate 78 due to a reactive force responsive to the force that presses the lock plate 78 against the lock plate side brake member 70 when an external force is exerted on the output shaft 18, and with the output plate side brake member 60 configured to generate a braking force for preventing reverse rotation by causing a portion of the output plate 64 to be pressed when an external force is exerted on the output shaft 18. This can generate a large braking force.

By using the motor with a reducer according to the first embodiment to open or close a power window or sun roof of a vehicle, for example, the window is prevented from opening under its own weight or vibration or being opened by a force from outside the vehicle.

The invention has been described with reference to the reference examples and embodiments. The embodiments of the present invention are not limited to those described above and appropriate combinations or replacements of the features of the reference examples and embodiments are also encompassed by the present invention. The reference examples and embodiments may be modified by way of combinations, rearranging of the processing sequence, design changes, etc., based on the knowledge of a skilled person, and such modifications are also within the scope of the present invention.

1. A reverse rotation prevention mechanism provided on a torque transmission path between an output shaft and a driving shaft of a motor, comprising:
a relative rotation inhibition unit configured to inhibit rotation of a braking rotational member provided on the torque transmission path from rotating relative to another member when an external force in a rotational direction is exerted on the output shaft; and
a first braking force generation unit configured to generate a braking force that prevents reverse rotation when an external force in the rotational direction is exerted on the output shaft, by causing a portion of the braking rotational member to be pressed, wherein
the relative rotation inhibition unit is provided in an area different from the first braking force generation unit.

2. The reverse rotation prevention mechanism according to claim 1, wherein
the other member is a driving shaft side rotational member provided on the torque transmission path more toward the driving shaft of the motor than the braking rotational member,
the driving shaft side rotational member is engaged with and rotated along with the braking rotational member when the motor is driven, and
the relative rotation inhibition unit is configured to generate an attractive force between the braking rotational member and the driving shaft side rotational member.

3. The reverse rotation prevention mechanism according to claim 2, wherein
the relative rotation inhibition unit is configured to disengage the braking rotational member and the driving shaft side rotational member from each other when the motor is stopped with the braking rotational member and the driving shaft side rotational member being engaged with each other.

4. The reverse rotation prevention mechanism according to claim 2, wherein
the relative rotation inhibition unit includes a magnet or a magnetic material provided in the braking rotational member and includes a magnetic material or a magnet provided in the driving shaft side rotational member, and
the relative rotation inhibition mechanism is configured to generate a magnetic attraction force between the braking rotational member and the driving shaft side rotational member.

5. The reverse rotation prevention mechanism according to claim 3, wherein
the relative rotation inhibition unit includes a magnet or a magnetic material provided in the braking rotational member and includes a magnetic material or a magnet provided in the driving shaft side rotational member, and
the relative rotation inhibition mechanism is configured to generate a magnetic attraction force between the braking rotational member and the driving shaft side rotational member.

6. The reverse rotation prevention mechanism according to claim 1, further comprising:
a braking and pressing member configured to be spaced apart from the braking rotational member due to a reactive force responsive to a force that presses the braking rotational member against the first braking force generation unit when an external force in the rotational direction is exerted on the output shaft; and
a second braking force generation unit configured to generate a braking force that prevents reverse rotation when an external force in the rotational direction is exerted on the output shaft, by causing a portion of the baking and pressing member to be pressed.

7. The reverse rotation prevention mechanism according to claim 2, further comprising:
a braking and pressing member configured to be spaced apart from the braking rotational member due to a reactive force responsive to a force that presses the braking rotational member against the first braking force generation unit when an external force in the rotational direction is exerted on the output shaft; and
a second braking force generation unit configured to generate a braking force that prevents reverse rotation when an external force in the rotational direction is exerted on the output shaft, by causing a portion of the baking and pressing member to be pressed.

8. The reverse rotation prevention mechanism according to claim 3, further comprising:
a braking and pressing member configured to be spaced apart from the braking rotational member due to a reactive force responsive to a force that presses the braking rotational member against the first braking force generation unit when an external force in the rotational direction is exerted on the output shaft; and
a second braking force generation unit configured to generate a braking force that prevents reverse rotation when an external force in the rotational direction is exerted on the output shaft, by causing a portion of the baking and pressing member to be pressed.

9. The reverse rotation prevention mechanism according to claim 4, further comprising:
a braking and pressing member configured to be spaced apart from the braking rotational member due to a reactive force responsive to a force that presses the braking rotational member against the first braking force generation unit when an external force in the rotational direction is exerted on the output shaft; and
a second braking force generation unit configured to generate a braking force that prevents reverse rotation when an external force in the rotational direction is exerted on the output shaft, by causing a portion of the baking and pressing member to be pressed.

10. A motor with a reducer comprising:
a motor;
a worm to which a rotational force of a driving shaft of the motor is transmitted;
a worm wheel in mesh with the worm;
an output shaft to which the rotational force exerted on the worm wheel is transmitted; and
the reverse rotation prevention mechanism according to claim 1.

11. The motor with a reducer according to claim 10, wherein
the reverse rotation prevention mechanism is provided on a torque transmission path between the driving shaft of the motor and the worm.

12. A motor with a reducer comprising:
a motor;
a worm to which a rotational force of a driving shaft of the motor is transmitted;
a worm wheel in mesh with the worm;
an output shaft to which the rotational force exerted on the worm wheel is transmitted; and
the reverse rotation prevention mechanism according to claim 6.

13. The motor with a reducer according to claim 12, wherein
the reverse rotation prevention mechanism is provided on a torque transmission path between the driving shaft of the motor and the worm.
